(19) United States
(12) Patent Application Publication
(10) Pub. No.: US 2022/0320926 A1
(43) Pub. Date: Oct. 6, 2022

(54) ROTOR FOR ROTARY ELECTRIC MACHINE

(71) Applicant: HONDA MOTOR CO., LTD., Tokyo (JP)

(72) Inventors: Masashi INOUE, Tokyo (JP); Yoshihisa KUBOTA, Saitama (JP)

(73) Assignee: HONDA MOTOR CO., LTD., Tokyo (JP)

(21) Appl. No.: 17/682,456

(22) Filed: Feb. 28, 2022

(30) Foreign Application Priority Data
Mar. 31, 2021 (JP) 2021-061123

(51) Int. Cl. H02K 1/276

(52) U.S. Cl. CPC H02K 1/2766; H02K 15/03

(57) ABSTRACT

In at least one of the magnet accommodating holes of the rotor core, the sheet-shaped member in which a distance between the first main surface of each of the permanent magnets and the first wall portion of each of the magnet accommodating holes or a distance between the second main surface of each of the permanent magnets and the second wall portion of each of the magnets accommodating hole is a first distance, and the sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is a second distance are laminated in the axial direction. The first distance is smaller than the second distance.

### CROSS-REFERENCE TO RELATED APPLICATIONS

This application is based on and claims priority under 35 USC 119 from Japanese Patent Application No. 2021-061123 filed on Mar. 31, 2021.

### TECHNICAL FIELD

The present disclosure relates to a rotor for a rotary electric machine.

### BACKGROUND ART

In related art, there has been known a rotary electric machine including a stator to which a coil is attached and a rotor to which a magnet is attached. In such a rotary electric machine, a magnetic field of the stator generated by a current passing through the coil and a magnetic field of the rotor generated by the magnet attached to the rotor interact with each other to rotationally drive the rotor. In this way, since the rotary electric machine can obtain rotational power from electric energy, in recent years, electric vehicles equipped with the rotary electric machine and driven by the rotational power of the rotary electric machine, such as hybrid vehicles, electric vehicles, and fuel cell vehicles, have been widely used as efforts for realizing a low-carbon society.

In addition, the rotary electric machine mounted on the electric vehicle strongly requires energy saving and high output, and for this purpose, it is desirable to reduce loss occurring in the rotary electric machine during no-load operation and low-load operation while maintaining the maximum output torque during high-load operation.

Therefore, for example, JP-A-2020-022218 discloses a rotor for a rotary electric machine including a rotor core in which a plurality of magnetic body accommodating holes are provided in a circumferential direction, and magnetic bodies accommodated in the accommodating holes. The magnetic body is a laminated body in which a hard magnetic body and a soft magnetic body having a property of having a saturation magnetic flux density lower than a residual magnetic flux density of the hard magnetic body are laminated in a magnetization direction of the hard magnetic body. In the rotor for the rotary electric machine according to JP-A-2020-022218, the soft magnetic body functions as a low saturation magnetic flux density portion, and it is possible to reduce loss occurring in the rotary electric machine during no-load operation and low-load operation of the rotary electric machine while maintaining the maximum output torque during high-load operation of the rotary electric machine.

However, in the rotor for the rotary electric machine of JP-A-2020-022218, it is necessary to form the magnetic body in which the soft magnetic body such as permalloy functioning as the low saturation magnetic flux density portion having a low saturation magnetic flux density and a hard magnetic body such as a neodymium magnet are laminated at the time of manufacturing, and thus there is a problem that man-hours are required to form the low saturation magnetic flux density portion. Further, in the rotor for the rotary electric machine of JP-A-2020-022218, since magnetic characteristics of the low saturation magnetic flux density portion are determined by a material used as the soft magnetic body and a lamination thickness, in order to change the saturation magnetic flux density of the low saturation magnetic flux density portion without changing a shape of the hard magnetic body, it is necessary to change the material used as the soft magnetic body or change the lamination thickness of the soft magnetic body to change a size of the magnetic body which is the laminated body, and there is a problem that the saturation magnetic flux density of the low saturation magnetic flux density portion cannot be easily adjusted.

### SUMMARY

The present disclosure provides a rotor for a rotary electric machine capable of easily forming a low saturation magnetic flux density portion.

According to an aspect of the present disclosure, there is provided a rotor for a rotary electric machine including:

a rotor core having a substantially annular shape centered on a rotation axis and configured by laminating a plurality of sheet-shaped members; and

a plurality of magnetic pole portions formed in the rotor core along a circumferential direction, in which:

each of the magnetic pole portions includes magnet accommodating holes formed in the rotor core and extending in an axial direction, and permanent magnets accommodated in the magnet accommodating hole;

each of the permanent magnets includes a first main surface extending in the axial direction and a second main surface extending in the axial direction;

each of the magnet accommodating holes includes a first wall portion facing the first main surface of each of the permanent magnets and extending in the axial direction, and a second wall portion facing the second main surface of each of the permanent magnets and extending in the axial direction;

in at least one of the magnet accommodating holes of the rotor core, the sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is a first distance, and the sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is a second distance are laminated in the axial direction; and

the first distance is a value smaller than the second distance including zero.

According to another aspect of the present disclosure, there is provided a rotor for a rotary electric machine including:

a rotor core having a substantially annular shape centered on a rotation axis and configured by laminating a plurality of sheet-shaped members; and

a plurality of magnetic pole portions formed in the rotor core along a circumferential direction, in which:

each of the magnetic pole portions includes a magnet accommodating hole formed in the rotor core and extending in an axial direction, and a permanent magnet accommodated in the magnet accommodating hole:

the permanent magnet includes a first main surface extending in the axial direction and a second main surface extending in the axial direction;

the magnet accommodating hole includes a first wall portion facing the first main surface of the permanent magnet and extending in the axial direction, and a second wall portion facing the second main surface of the permanent magnet and extending in the axial direction; and

a plurality of protrusions protruding toward the permanent magnet to form at least one of the first wall portion and the second wall portion, and formed along the axial direction; and

a plurality of voids formed between the plurality of protrusions which are adjacent, and formed along the axial direction are provided.

According to the present disclosure, a low saturation magnetic flux density portion having a lower saturation magnetic flux density than that of a portion where the sheet-shaped members are laminated in the axial direction is formed without the voids being formed is formed between the first main surface of the permanent magnet and the first wall portion of the magnet accommodating hole, or between the second main surface of the permanent magnet and the second wall portion of the magnet accommodating hole. In this way, the low saturation magnetic flux density portion can be easily formed.

### BRIEF DESCRIPTION OF DRAWINGS

FIG. 1 is a front view of a rotary electric machine including a rotor for the rotary electric machine according to a first embodiment of the present disclosure.

FIG. 2 is a front view of a magnetic pole portion of the rotor in FIG. 1.

FIG. 3A is a cross-sectional view taken along a line A-A in FIG. 2.

FIG. 3B is a cross-sectional view taken along a line B-B in FIG. 2.

FIG. 3C is a cross-sectional view taken along a line C-C in FIG. 2.

FIG. 4A is a front view illustrating a first electromagnetic steel sheet of the rotor in FIG. 1 and an enlarged view of a main part of thereof.

FIG. 4B is a front view illustrating a second electromagnetic steel sheet of the rotor in FIG. 1 and an enlarged view of a main part thereof.

FIG. 5 is a graph illustrating maximum output torque-loss during no-load operation characteristics of the rotary electric machine when a space factor of a first low saturation magnetic flux density portion, a second low saturation magnetic flux density portion, and a third low saturation magnetic flux density portion of the rotor for the rotary electric machine according to the first embodiment in FIG. 1 is changed.

FIG. 6A is a front view of an electromagnetic steel sheet according to a first example of a rotor for a rotary electric machine according to a second embodiment of the present disclosure.

FIG. 6B is a front view of an electromagnetic steel sheet according to a second example of the rotor for the rotary electric machine according to the second embodiment of the present disclosure.

FIG. 6C is a front view of an electromagnetic steel sheet according to a third example of the rotor for the rotary electric machine according to the second embodiment of the present disclosure.

FIG. 6D is a front view of an electromagnetic steel sheet according to a fourth example of the rotor for the rotary electric machine according to the second embodiment of the present disclosure.

FIG. 6E is a front view of an electromagnetic steel sheet according to a fifth example of the rotor for the rotary electric machine according to the second embodiment of the present disclosure, and enlarged views of main parts of a first magnetic pole portion forming portion, a second magnetic pole portion forming portion, and a third magnetic pole portion forming portion.

FIG. 7 is a front view of a rotor for a rotary electric machine according to a third embodiment of the present invention and an enlarged view of a main part thereof.

FIG. 8 is a cross-sectional view of a first low saturation magnetic flux density portion in FIG. 7.

### DESCRIPTION OF EMBODIMENTS

Hereinafter, embodiments of a rotary electric machine including a rotor for the rotary electric machine according to the present disclosure will be described with reference to the accompanying drawings. It should be noted that the drawings are viewed in a direction of reference numerals. In addition, in the present specification and the like, unless otherwise specified, the terms “axial direction”, “radial direction”, and “circumferential direction” refer to directions based on a rotation axis of the rotor. An axially inner side refers to a central side of the rotary electric machine in the axial direction, and an axially outer side refers to a side away from a center of the rotary electric machine in the axial direction. A circumferentially inner side refers to a circumferentially central side of a magnetic pole portion, and a circumferentially outer side refers to a side away from a circumferential center of the magnetic pole portion.

### First Embodiment

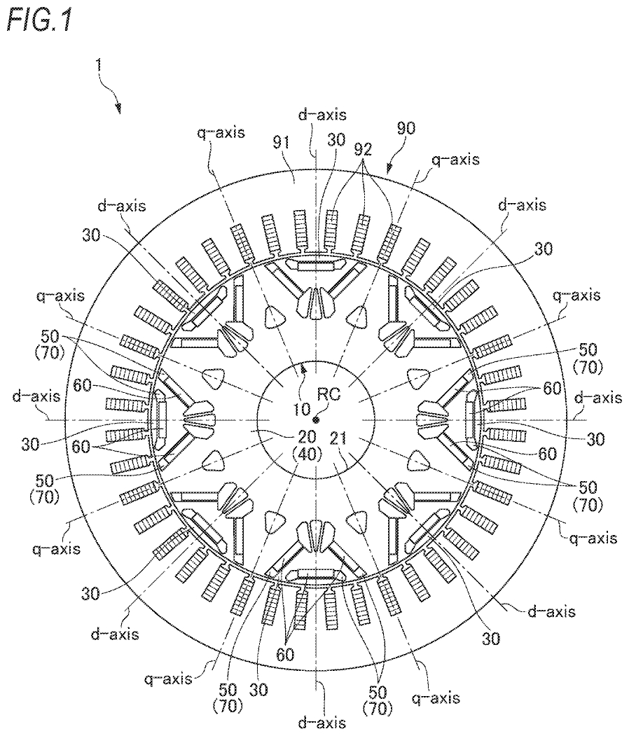

First, a rotor for a rotary electric machine according to a first embodiment of the present disclosure will be described with reference to FIGS. 1 to 5.

<Rotary Electric Machine>

As illustrated in FIG. 1, a rotary electric machine 1 according to the present embodiment includes a substantially annular rotor 10 which rotates about a rotation axis RC as a rotation axis and is centered on the rotation axis RC, and a stator 90 which is disposed so as to surround an outer circumferential surface of the rotor 10.

<Rotor>

As illustrated in FIG. 1, the rotor 10 for the rotary electric machine according to the present embodiment includes a rotor core 20 having a substantially annular shape centered on the rotation axis RC, and a plurality of magnetic pole portions 30 formed in the rotor core 20 along a circumferential direction.

The rotor core 20 has the substantially annular shape centered on the rotation axis RC. An inner circumferential surface 21 of the rotor core 20 is a wall surface of a rotor shaft hole in which a rotor shaft (not illustrated) is tightened into annular inside of the rotor core 20 by press-fitting or the like.

The rotor core 20 is formed by laminating a plurality of electromagnetic steel sheets 40, each of which has a substantially annular shape centered on the rotation axis RC in an axial direction.

The plurality of magnetic pole portions 30 are formed at equal intervals along the circumferential direction. In the present embodiment, eight magnetic pole portions 30 are formed at equal intervals along the circumferential direction, that is, at intervals of 45 degrees.

In the present specification and the like, when viewed from the axial direction, an axis extending radially through a circumferential center of each magnetic pole portion 30 is defined as a d-axis (d-axis in the drawing), and an axis extending radially through a circumferential end portion of each magnetic pole portion 30 and separated from the d-axis by an electrical angle of 90 degrees is defined as a q-axis (q-axis in the drawing).

Each magnetic pole portion 30 has magnet accommodating holes 50 formed in the rotor core 20 and extending in the axial direction, and permanent magnets 60 accommodated in the magnet accommodating holes 50, respectively. In the present embodiment, each magnetic pole portion 30 has three magnet accommodating holes 50 and three permanent magnets 60 accommodated in the three magnet accommodating holes 50, respectively.

The electromagnetic steel sheet 40 includes a plurality of magnetic pole portion forming portions 80 formed along the circumferential direction. The plurality of magnetic pole portion forming portions 80 are formed at equal intervals along the circumferential direction. In the present embodiment, eight magnetic pole portion forming portions 80 are formed at equal intervals along the circumferential direction, that is, at intervals of 45 degrees. Each magnetic pole portion 30 of the rotor 10 is formed by laminating the plurality of electromagnetic steel sheets 40 in the axial direction and laminating magnetic pole portion forming portions 80 of the electromagnetic steel sheets 40 in the axial direction.

A plurality of magnet insertion holes 70 penetrating in the axial direction are formed along the circumferential direction in the magnetic pole portion forming portions 80 of the electromagnetic steel sheets 40. The magnet accommodating hole 50 of the rotor 10 is formed by laminating the plurality of electromagnetic steel sheets 40 in the axial direction and overlapping the magnet insertion holes 70 formed in the electromagnetic steel sheets 40 in the axial direction.

<Stator>

The stator 90 includes a substantially annular stator core 91 disposed at a predetermined interval radially from an outer circumferential surface of the rotor 10, and stator coils 92 attached to the stator core 91.

When a current is supplied to the stator coil 92, a magnetic field is generated in the stator 90. The magnetic field generated in the stator 90 and a magnetic field generated by the permanent magnet 60 of each magnetic pole portion 30 of the rotor 10 interact with each other, thereby rotating the rotor 10. In this way, the rotary electric machine 1 is rotationally driven.

<Magnetic Pole Portion>

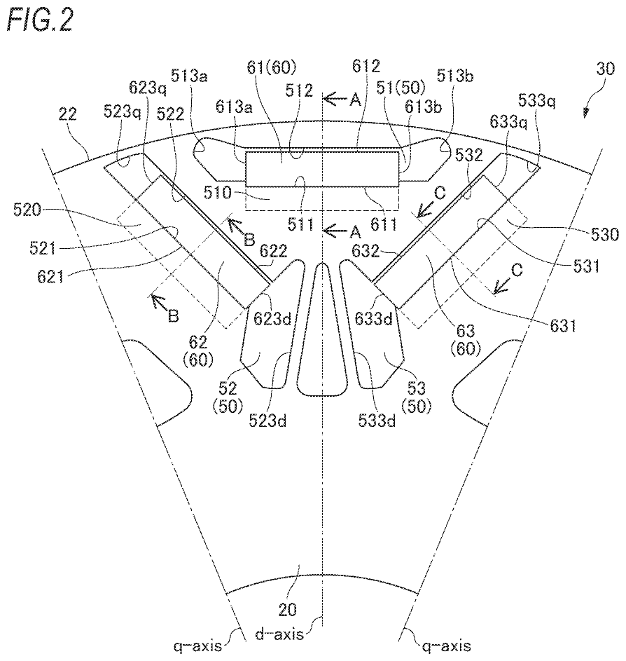

As illustrated in FIG. 2, when viewed in the axial direction, the magnet accommodating hole 50 formed in each magnetic pole portion 30 includes a first magnet accommodating hole 51 extending in the circumferential direction so as to be substantially orthogonal to the d-axis and having a shape substantially symmetrical with respect to the d-axis in the vicinity of an outer circumferential surface 22 of the rotor core 20, a second magnet accommodating hole 52 formed on one side in the circumferential direction (counterclockwise side in FIG. 2) with respect to the d-axis, and a third magnet accommodating hole 53 formed on the other side in the circumferential direction (clockwise side in FIG. 2) with respect to the d-axis. The second magnet accommodating hole 52 and the third magnet accommodating hole 53 are disposed in a substantially V-shape in which a distance in the circumferential direction increases radially outward. Therefore, the second magnet accommodating hole 52 extends so as to be inclined with respect to the circumferential direction, that is, toward the circumferentially outer side and radially outward. The third magnet accommodating hole 53 extends so as to be inclined with respect to the circumferential direction, that is, toward the circumferentially outer side and radially outward.

The three permanent magnets 60 include a first permanent magnet 61 accommodated in the first magnet accommodating hole 51, a second permanent magnet 62 accommodated in the second magnet accommodating hole 52, and a third permanent magnet 63 accommodated in the third magnet accommodating hole 53. Each of the first permanent magnet 61, the second permanent magnet 62, and the third permanent magnet 63 has a substantially rectangular cross section when viewed in the axial direction, and has a flat plate shape extending in the axial direction.

The first permanent magnet 61 has a rectangular shape whose longitudinal direction is a direction substantially orthogonal to the d-axis in the vicinity of the outer circumferential surface 22 of the rotor core 20 when viewed in the axial direction. The first permanent magnet 61 includes an inner surface 611 facing radially inward and extends in the axial direction, an outer surface 612 facing radially outward and extending in the axial direction, a first end surface 613a connecting the inner surface 611 and the outer surface 612 on one circumferential end side and extending in the axial direction, and a second end surface 613b connecting the inner surface 611 and the outer surface 612 on the other circumferential end side and extending in the axial direction. The first permanent magnet 61 is magnetized in a direction orthogonal to the inner surface 611 and the outer surface 612 when viewed in the axial direction.

When viewed in the axial direction, the first magnet accommodating hole 51 includes an inner wall portion 511 facing the inner surface 611 of the first permanent magnet 61 and extending in the axial direction, an outer wall portion 512 facing the outer surface 612 of the first permanent magnet 61 and extending in the axial direction, a first end wall portion 513a connecting an end portion of the inner wall portion 511 on one side in the circumferential direction and an end portion of the outer wall portion 512 on one side in the circumferential direction and extending in the axial direction, and a second end wall portion 513b connecting an end portion of the inner wall portion 511 on the other side in the circumferential direction and an end portion of the outer wall portion 512 on the other side in the circumferential direction and extending in the axial direction. The first end wall portion 513a and the second end wall portion 513b extend from end portions of the inner wall portion 511 and end portions of the outer wall portion 512 toward outer sides in the longitudinal direction of the first permanent magnet 61 in a largely curved manner when viewed in the axial direction, and flux barriers are formed on outer sides of the first end surface 613a and the second end surface 613b in the longitudinal direction of the first permanent magnet 61.

When viewed in the axial direction, the second permanent magnet 62 extends so as to be inclined with respect to the circumferential direction on one side in the circumferential direction with respect to the d-axis (counterclockwise side in FIG. 2), that is, toward the circumferentially outer side and radially outward, and has a substantially rectangular shape whose longitudinal direction is the extending direction. The second permanent magnet 62 includes an inner surface 621 facing radially inward and extending in the longitudinal direction and the axial direction, an outer surface 622 facing radially outward and extending in the longitudinal direction and the axial direction, a d-axis side end surface 623d connecting an end portion of the inner surface 621 on a d-axis side and an end portion of the outer surface 622 on the d-axis side and extending in the axial direction, and a q-axis side end surface 623q connecting an end portion of the inner surface 621 on a q-axis side and an end portion of the outer surface 622 on the q-axis side and extending in the axial direction. The second permanent magnet 62 is disposed such that the d-axis side end surface 623d is located radially inward of the first permanent magnet 61 and the q-axis side end surface 623q is located at a position substantially the same as that of the first permanent magnet 61 in a radial direction. The second permanent magnet 62 is magnetized in a direction orthogonal to the inner surface 621 and the outer surface 622 when viewed in the axial direction.

When viewed in the axial direction, the second magnet accommodating hole 52 includes an inner wall portion 521 facing the inner surface 621 of the second permanent magnet 62 and extending in the axial direction, an outer wall portion 522 facing the outer surface 622 of the second permanent magnet 62 and extending in the axial direction, a d-axis side wall portion 523d connecting an end portion of the inner wall portion 521 on the d-axis side and an end portion of the outer wall portion 522 on the d-axis side and extending in the axial direction, and a q-axis side wall portion 523q connecting an end portion of the inner wall portion 521 on the q-axis side and an end portion of the outer wall portion 522 on the q-axis side and extending in the axial direction. When viewed in the axial direction, the d-axis side wall portion 523d and the q-axis side wall portion 523q extend from end portions of the inner wall portion 521 and end portions of the outer side wall portion 522 so as to be largely curved toward outer sides in the longitudinal direction of the second permanent magnet 62, and flux barrier are formed on outer sides of the d-axis side end surface 623d and the q-axis side end surface 623q in the longitudinal direction of the second permanent magnet 62.

When viewed in the axial direction, the third permanent magnet 63 extends so as to be inclined with respect to the circumferential direction on the other side in the circumferential direction with respect to the d-axis (clockwise side in FIG. 2), that is, toward the circumferentially outer side and radially outward, and has a substantially rectangular shape whose longitudinal direction is an extending direction. The third permanent magnet 63 includes an inner surface 631 facing radially inward and extending in the longitudinal direction and the axial direction, an outer surface 632 facing radially outward and extending in the longitudinal direction and the axial direction, a d-axis side end surface 633d connecting an end portion of the inner surface 631 on a d-axis side and an end portion of the outer surface 632 on the d-axis side and extending in the axial direction, and a q-axis side end surface 633q connecting an end portion of the inner surface 631 on a q-axis side and an end portion of the outer surface 632 on the q-axis side and extending in the axial direction. The third permanent magnet 63 is disposed such that the d-axis side end surface 633d is located radially inward of the first permanent magnet 61 and the q-axis side end surface 633q is located at a position substantially the same as that of the first permanent magnet 61 in the radial direction. The third permanent magnet 63 is magnetized in a direction orthogonal to the inner surface 631 and the outer surface 632 when viewed in the axial direction.

When viewed in the axial direction, the third magnet accommodating hole 53 includes an inner wall portion 531 facing the inner surface 631 of the third permanent magnet 63 and extending in the axial direction, an outer wall portion 532 facing the outer surface 632 of the third permanent magnet 63 and extending in the axial direction, a d-axis side wall portion 533d connecting an end portion of the inner wall portion 531 on the d-axis side and an end portion of the outer wall portion 532 on the d-axis side and extending in the axial direction, and a q-axis side wall portion 533q connecting an end portion of the inner wall portion 531 on the q-axis side and an end portion of the outer wall portion 532 on the q-axis side and extending in the axial direction. When viewed in the axial direction, the d-axis side wall portion 533d and the q-axis side wall portion 533q extend from ends portion of the inner wall portion 531 and end portions of the outer side wall portion 532 so as to be largely curved toward outer sides in the longitudinal direction of the third permanent magnet 63, and flux barriers are formed on outer sides of the d-axis side end surface 633d and the q-axis side end surface 633q in the longitudinal direction of the third permanent magnet 63.

<Low Saturation Magnetic Flux Density Portion>

Loss occurring in the rotary electric machine 1 includes iron loss and copper loss. The iron loss is loss which occurs due to physical properties of the rotor core 20 and the stator core 91. The copper loss is loss which occurs due to a resistance component of the stator coil 92. During no-load operation in which no electric power is supplied to the stator coil 92 and during low-load operation in which the electric power supplied to the stator coil 92 is small, the loss occurring in the rotary electric machine 1 is such that the copper loss is small and the iron loss is dominant since a current flowing through the stator coil 92 is zero or small. On the other hand, during high-load operation in which the electric power supplied to the stator coil 92 is large, the loss occurring in the rotary electric machine 1 such that the copper loss is dominant since a current flowing through the stator coil 92 is large.

Therefore, it is desirable that the rotary electric machine 1 reduces the iron loss by reducing a magnetic flux generated from the permanent magnet 60 during the no-load operation and the low-load operation while maintaining the maximum output torque during the high-load operation.

(First Low Saturation Magnetic Flux Density Portion)

At least one of the inner wall portion 511 and the outer wall portion 512 of the first magnet accommodating hole 51 is provided with a first low saturation magnetic flux density portion 510 having a low saturation magnetic flux density. In the present embodiment, the first low saturation magnetic flux density portion 510 is formed in the inner wall portion 511 of the first magnet accommodating hole 51.

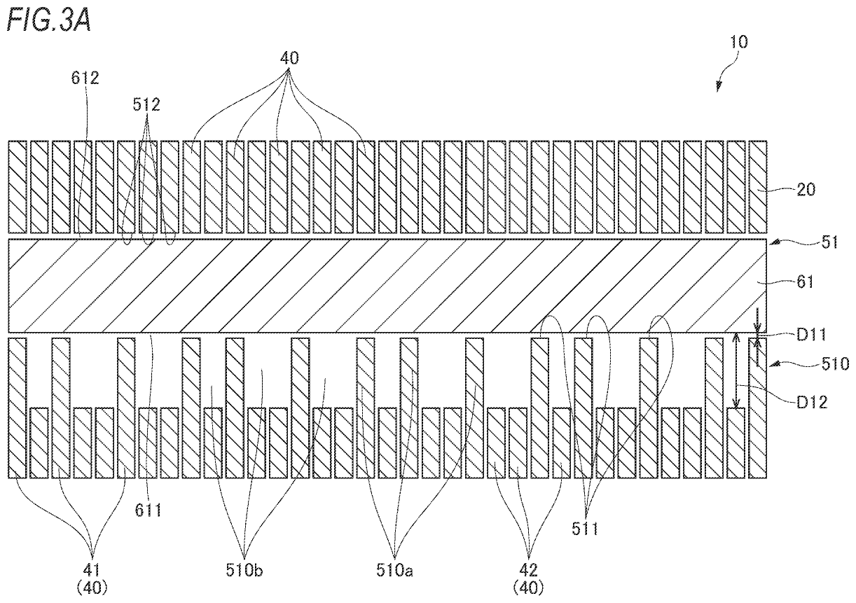

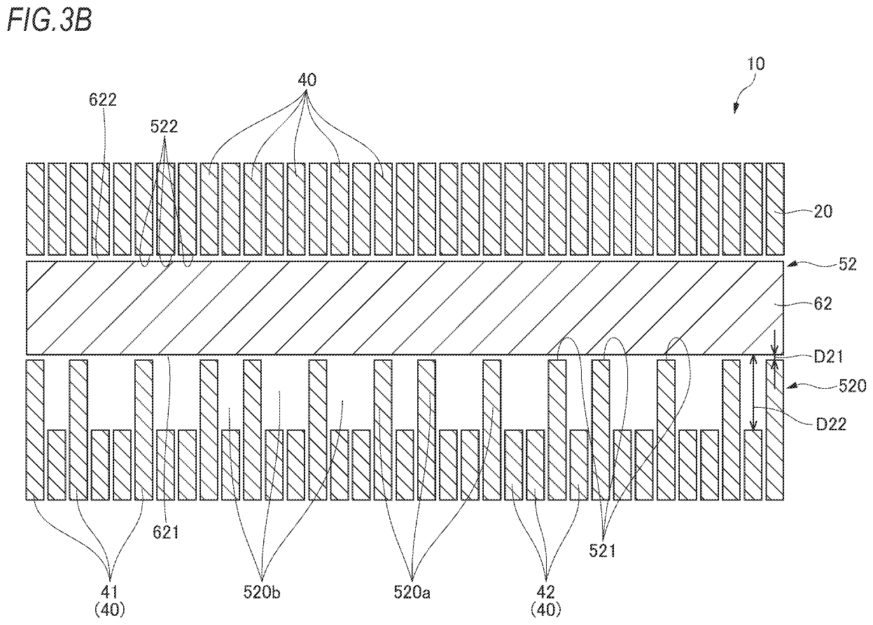

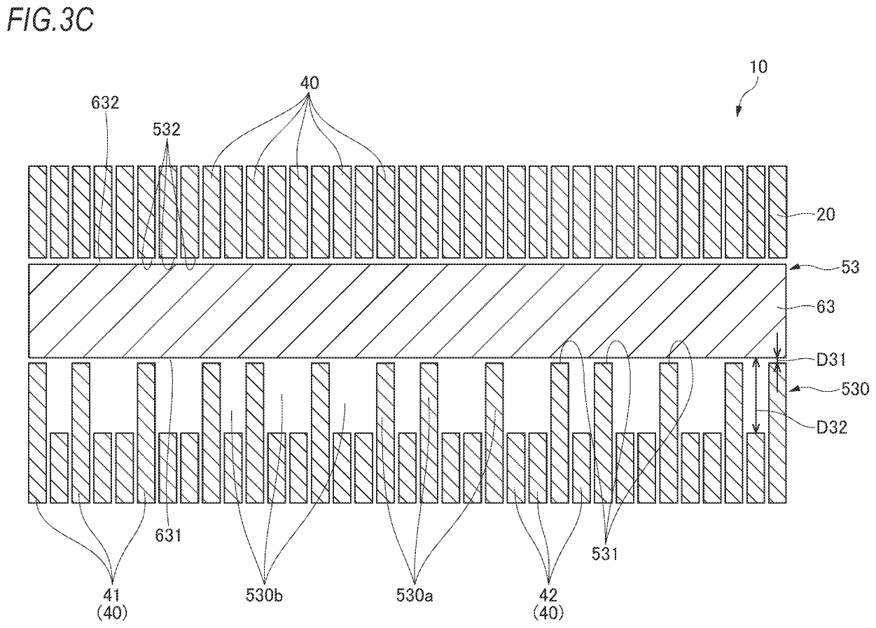

As illustrated in FIG. 3A, in the rotor core 20, the electromagnetic steel sheets 40 in which a distance between the inner surface 611 of the first permanent magnet 61 and the inner wall portion 511 of the first magnet accommodating hole 51 is a first distance D11 and the electromagnetic steel sheets 40 in which a distance between the inner surface 611 of the first permanent magnet 61 and the inner wall portion 511 of the first magnet accommodating hole 51 is a second distance D12 are laminated in the axial direction. At this time, the first distance D11 is shorter than the second distance D12. The first distance D11 may be zero. When the first distance D11 is zero, the inner surface 611 of the first permanent magnet 61 and the inner wall portion 511 of the first magnet accommodating hole 51 are in contact with each other. The first low saturation magnetic flux density portion 510 includes a plurality of first protrusions 510a protruding toward the inner surface 611 of the first permanent magnet 61 to form the inner wall portion 511 of the first magnet accommodating hole 51 and formed along the axial direction, and a plurality of first voids 510b formed between the adjacent first protrusions 510a and along the axial direction. Therefore, the plurality of first protrusions 510a and the plurality of first voids 510b are formed along the axial direction in the first low saturation magnetic flux density portion 510.

As described above, the rotor core 20 is formed by laminating the plurality of electromagnetic steel sheets 40, each of which has the substantially annular shape centered on the rotation axis RC in the axial direction. However, since a relative permeability of the first voids 510b is lower than that of the electromagnetic steel sheets 40, a saturation magnetic flux density of the first low saturation magnetic flux density portion 510 is lower than that of a portion of the rotor core 20 where the electromagnetic steel sheets 40 are laminated in the axial direction without the voids being formed.

Therefore, when a magnetic flux density of a magnetic field generated in a magnetization direction of the first permanent magnet 61 is close to the saturation magnetic flux density of the first low saturation magnetic flux density portion 510, magnetic saturation in which a magnetic permeability decreases occurs in the first low saturation magnetic flux density portion 510, and thus a magnetic resistance increases, and a magnetic flux generated in the magnetization direction of the first permanent magnet 61 is reduced as compared with a case where the first low saturation magnetic flux density portion 510 is not formed.

The saturation magnetic flux density of the first low saturation magnetic flux density portion 510 is lower than that of the portion of the rotor core 20 where the electromagnetic steel sheets 40 are laminated in the axial direction without the voids being formed, and therefore, during the no-load operation and the low-load operation of the rotary electric machine 1, the magnetic saturation in which the magnetic permeability decreases can occur in the first low saturation magnetic flux density portion 510, and the magnetic flux generated in the magnetization direction of the first permanent magnet 61 can be reduced. Since the iron loss is dominant in the loss occurring in the rotary electric machine 1 during the no-load operation and the low-load operation of the rotary electric machine 1, the loss occurring in the rotary electric machine 1 during the no-load operation and the low-load operation of the rotary electric machine 1 can be reduced.

On the other hand, during the high-load operation of the rotary electric machine 1, a large current is supplied to the stator coil 92, and a large magnetic field is generated from the stator 90. At this time, a magnetic flux generated in the magnetization direction of the first permanent magnet 61 is offset by a d-axis interlinkage magnetic flux generated by a d-axis current flowing through the stator coil 92, and thus is reduced as compared with a case of the no-load operation of the rotary electric machine 1. Therefore, even if the first low saturation magnetic flux density portion 510 is formed such that the magnetic saturation occurs during the no-load operation and the low-load operation of the rotary electric machine 1, the magnetic saturation is less likely to occur in the first low saturation magnetic flux density portion 510 during the high-load operation of the rotary electric machine 1. Therefore, even if the first low saturation magnetic flux density portion 510 is formed in the inner wall portion 511 of the first magnet accommodating hole 51, the magnetic flux generated in the magnetization direction of the first permanent magnet 61 during the high-load operation of the rotary electric machine 1 is almost the same as that in a case where the first low saturation magnetic flux density portion 510 is not formed, and the rotary electric machine 1 can suppress a decrease in the maximum output torque during the high-load operation.

In this way, in the rotor 10 for the rotary electric machine 1, since the first low saturation magnetic flux density portion 510 is formed in the inner wall portion 511 of the first magnet accommodating hole 51, it is possible to reduce the loss occurring in the rotary electric machine 1 during the no-load operation and the low-load operation of the rotary electric machine 1 while maintaining the maximum output torque during the high-load operation of the rotary electric machine 1. In addition, since the first low saturation magnetic flux density portion 510 is formed by the plurality of first protrusions 510a formed along the axial direction and the plurality of first voids 510b formed between the adjacent first protrusions 510a and along the axial direction, the first low saturation magnetic flux density portion 510 can be easily formed. Further, the saturation magnetic flux density of the first low saturation magnetic flux density portion 510 can be easily adjusted by adjusting a proportion of the first protrusions 510a and a proportion of the first voids 510b in the first low saturation magnetic flux density portion 510.

(Second Low Saturation Magnetic Flux Density Portion)

At least one of the inner wall portion 521 and the outer wall portion 522 of the second magnet accommodating hole 52 is provided with a second low saturation magnetic flux density portion 520 having a low saturation magnetic flux density. In the present embodiment, the second low saturation magnetic flux density portion 520 is formed in the inner wall portion 521 of the second magnet accommodating hole 52.

As illustrated in FIG. 3B, in the rotor core 20, the electromagnetic steel sheets 40 in which a distance between the inner surface 621 of the second permanent magnet 62 and the inner wall portion 521 of the second magnet accommodating hole 52 is a first distance D21 and the electromagnetic steel sheets 40 in which a distance between the inner surface 621 of the second permanent magnet 62 and the inner wall portion 521 of the second magnet accommodating hole 52 is a second distance D22 are laminated in the axial direction. At this time, the first distance D21 is shorter than the second distance D22. The first distance D21 may be zero. When the first distance D21 is zero, the inner surface 621 of the second permanent magnet 62 and the inner wall portion 521 of the second magnet accommodating hole 52 are in contact with each other. The second low saturation magnetic flux density portion 520 includes a plurality of second protrusions 520a protruding toward the inner surface 621 of the second permanent magnet 62 to form the inner wall portion 521 of the second magnet accommodating hole 52 and formed along the axial direction, and a plurality of second voids 520b formed between the adjacent second protrusions 520a and along the axial direction. Therefore, the plurality of second protrusions 520a and the plurality of second voids 520b are formed along the axial direction in the second low saturation magnetic flux density portion 520.

As described above, the rotor core 20 is formed by laminating the plurality of electromagnetic steel sheets 40, each of which has the substantially annular shape centered on the rotation axis RC in the axial direction. However, since a relative permeability of the second voids 520b is lower than that of the electromagnetic steel sheets 40, a saturation magnetic flux density of the second low saturation magnetic flux density portion 520 is lower than that of a portion of the rotor core 20 where the electromagnetic steel sheets 40 are laminated in the axial direction without the voids being formed.

Therefore, when a magnetic flux density of a magnetic field generated in a magnetization direction of the second permanent magnet 62 is close to the saturation magnetic flux density of the second low saturation magnetic flux density portion 520, magnetic saturation in which a magnetic permeability decreases occurs in the second low saturation magnetic flux density portion 520, and thus a magnetic resistance increases, and a magnetic flux generated in the magnetization direction of the second permanent magnet 62 is reduced as compared with a case where the second low saturation magnetic flux density portion 520 is not formed.

The saturation magnetic flux density of the second low saturation magnetic flux density portion 520 is lower than that of the portion of the rotor core 20 where the electromagnetic steel sheets 40 are laminated in the axial direction without the voids being formed, and therefore, during the no-load operation and the low-load operation of the rotary electric machine 1, the magnetic saturation in which the magnetic permeability decreases can occur in the second low saturation magnetic flux density portion 520, and the magnetic flux generated in the magnetization direction of the second permanent magnet 62 can be reduced. Since the iron loss is dominant in the loss occurring in the rotary electric machine 1 during the no-load operation and the low-load operation of the rotary electric machine 1, the loss occurring in the rotary electric machine 1 during the no-load operation and the low-load operation of the rotary electric machine 1 can be reduced.

On the other hand, during the high-load operation of the rotary electric machine 1, a large current is supplied to the stator coil 92, and a large magnetic field is generated from the stator 90. At this time, a magnetic flux generated in the magnetization direction of the second permanent magnet 62 is offset by a d-axis interlinkage magnetic flux generated by a d-axis current flowing through the stator coil 92, and thus is reduced as compared with the case of the no-load operation of the rotary electric machine 1. Therefore, even if the second low saturation magnetic flux density portion 520 is formed such that the magnetic saturation occurs during the no-load operation and the low-load operation of the rotary electric machine 1, the magnetic saturation is less likely to occur in the second low saturation magnetic flux density portion 520 during the high-load operation of the rotary electric machine 1. Therefore, even if the second low saturation magnetic flux density portion 520 is formed in the inner wall portion 521 of the second magnet accommodating hole 52, the magnetic flux generated in the magnetization direction of the second permanent magnet 62 during the high-load operation of the rotary electric machine 1 is almost the same as that in a case where the second low saturation magnetic flux density portion 520 is not formed, and the rotary electric machine 1 can suppress a decrease in the maximum output torque during the high-load operation.

In this way, in the rotor 10 for the rotary electric machine 1, since the second low saturation magnetic flux density portion 520 is formed in the inner wall portion 521 of the second magnet accommodating hole 52, it is possible to reduce the loss occurring in the rotary electric machine 1 during the no-load operation and the low-load operation of the rotary electric machine 1 while maintaining the maximum output torque during the high-load operation of the rotary electric machine 1. In addition, since the second low saturation magnetic flux density portion 520 is formed by the plurality of second protrusions 520a formed along the axial direction and the plurality of second voids 520b formed between the adjacent second protrusions 520a and along the axial direction, the second low saturation magnetic flux density portion 520 can be easily formed. Further, the saturation magnetic flux density of the second low saturation magnetic flux density portion 520 can be easily adjusted by adjusting a proportion of the second protrusions 520a and a proportion of the second voids 520b in the second low saturation magnetic flux density portion 520.

(Third Low Saturation Magnetic Flux Density Portion)

At least one of the inner wall portion 531 and the outer wall portion 532 of the third magnet accommodating hole 53 is provided with a third low saturation magnetic flux density portion 530 having a low saturation magnetic flux density. In the present embodiment, the third low saturation magnetic flux density portion 530 is formed in the inner wall portion 531 of the third magnet accommodating hole 53.

As illustrated in FIG. 3C, in the rotor core 20, the electromagnetic steel sheets 40 in which a distance between the inner surface 631 of the third permanent magnet 63 and the inner wall portion 531 of the third magnet accommodating hole 53 is a first distance D31 and the electromagnetic steel sheets 40 in which a distance between the inner surface 631 of the third permanent magnet 63 and the inner wall portion 531 of the third magnet accommodating hole 53 is a second distance D32 are laminated in the axial direction. At this time, the first distance D31 is shorter than the second distance D32. The first distance D31 may be zero. When the first distance D31 is zero, the inner surface 631 of the third permanent magnet 63 and the inner wall portion 531 of the third magnet accommodating hole 53 are in contact with each other. The third low saturation magnetic flux density portion 530 includes a plurality of third protrusions 530a protruding toward the inner surface 631 of the third permanent magnet 63 to form the inner wall portion 531 of the third magnet accommodating hole 53 and formed along the axial direction, and a plurality of third voids 530b formed between the adjacent third protrusions 530a and along the axial direction. Therefore, the plurality of third protrusions 530a and the plurality of third voids 530b are formed along the axial direction in the third low saturation magnetic flux density portion 530.

As described above, the rotor core 20 is formed by laminating the plurality of electromagnetic steel sheets 40, each of which has the substantially annular shape centered on the rotation axis RC in the axial direction. However, since a relative permeability of the third voids 530b is lower than that of the electromagnetic steel sheets 40, a saturation magnetic flux density of the third low saturation magnetic flux density portion 530 is lower than that of a portion of the rotor core 20 where the electromagnetic steel sheets 40 are laminated in the axial direction without the voids being formed.

Therefore, when a magnetic flux density of a magnetic field generated in a magnetization direction of the third permanent magnet 63 is close to the saturation magnetic flux density of the third low saturation magnetic flux density portion 530, magnetic saturation in which a magnetic permeability decreases occurs in the third low saturation magnetic flux density portion 530, and thus a magnetic resistance increases, and a magnetic flux generated in the magnetization direction of the third permanent magnet 63 is reduced as compared with a case where the third low saturation magnetic flux density portion 530 is not formed.

The saturation magnetic flux density of the third low saturation magnetic flux density portion 530 is lower than that of the portion of the rotor core 20 where the electromagnetic steel sheets 40 are laminated in the axial direction without the voids being formed, and therefore, during the no-load operation and the low-load operation of the rotary electric machine 1, the magnetic saturation in which the magnetic permeability decreases can occur in the third low saturation magnetic flux density portion 530, and the magnetic flux generated in the magnetization direction of the third permanent magnet 63 can be reduced. Since the iron loss is dominant in the loss occurring in the rotary electric machine 1 during the no-load operation and the low-load operation of the rotary electric machine 1, the loss occurring in the rotary electric machine 1 during the no-load operation and the low-load operation of the rotary electric machine 1 can be reduced.

On the other hand, during the high-load operation of the rotary electric machine 1, a large current is supplied to the stator coil 92, and a large magnetic field is generated from the stator 90. At this time, a magnetic flux generated in the magnetization direction of the third permanent magnet 63 is offset by a d-axis interlinkage magnetic flux generated by a d-axis current flowing through the stator coil 92, and thus is reduced as compared with the case of the no-load operation of the rotary electric machine 1. Therefore, even if the third low saturation magnetic flux density portion 530 is formed such that the magnetic saturation occurs during the no-load operation and the low-load operation of the rotary electric machine 1, the magnetic saturation is less likely to occur in the third low saturation magnetic flux density portion 530 during the high-load operation of the rotary electric machine 1. Therefore, even if the third low saturation magnetic flux density portion 530 is formed in the inner wall portion 531 of the third magnet accommodating hole 53, the magnetic flux generated in the magnetization direction of the third permanent magnet 63 during the high-load operation of the rotary electric machine 1 is almost the same as that in a case where the third low saturation magnetic flux density portion 530 is not formed, and the rotary electric machine 1 can suppress a decrease in the maximum output torque during the high-load operation.

In this way, in the rotor 10 for the rotary electric machine 1, since the third low saturation magnetic flux density portion 530 is formed in the inner wall portion 531 of the third magnet accommodating hole 53, it is possible to reduce the loss occurring in the rotary electric machine 1 during the no-load operation and the low-load operation of the rotary electric machine 1 while maintaining the maximum output torque during the high-load operation of the rotary electric machine 1. In addition, since the third low saturation magnetic flux density portion 530 is formed by the plurality of third protrusions 530a formed along the axial direction and the plurality of third voids 530b formed between the adjacent third protrusions 530a and along the axial direction, the third low saturation magnetic flux density portion 530 can be easily formed. Further, the saturation magnetic flux density of the third low saturation magnetic flux density portion 530 can be easily adjusted by adjusting a proportion of the third protrusions 530a and a proportion of the third voids 530b in the third low saturation magnetic flux density portion 530.

<Electromagnetic Steel Sheet>

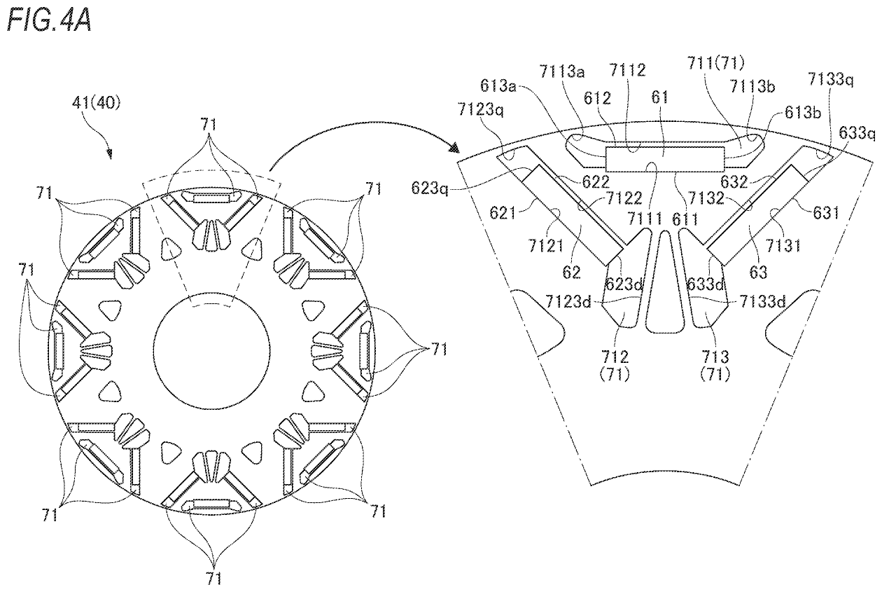

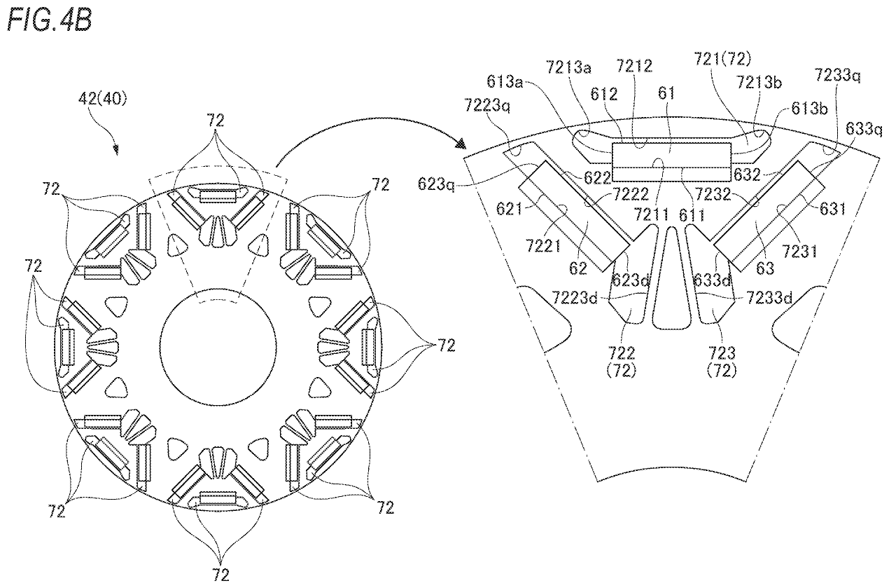

As illustrated in FIGS. 4A and 4B, the magnet insertion hole 70 formed in each magnetic pole portion forming portion 80 of the electromagnetic steel sheet 40 includes a protrusion forming magnet insertion hole 71 and a void forming magnet insertion hole 72. In the present embodiment, the electromagnetic steel sheet 40 includes a first electromagnetic steel sheet 41 in which the protrusion forming magnet insertion hole 71 is formed and a second electromagnetic steel sheet 42 in which the void forming magnet insertion hole 72 is formed.

As illustrated in FIG. 4A, the protrusion forming magnet insertion holes 71 formed in each magnetic pole portion forming portion 80 of the first electromagnetic steel sheet 41 includes a first protrusion forming magnet insertion hole 711 overlapping in the axial direction to form the first magnet accommodating hole 51, a second protrusion forming magnet insertion hole 712 overlapping in the axial direction to form the second magnet accommodating hole 52, and a third protrusion forming magnet insertion hole 713 overlapping in the axial direction to form the third magnet accommodating hole 53. The distance between the inner surface 611 of the first permanent magnet 61 and the inner wall portion 511 of the first magnet accommodating hole 51 is the first distance D11 in the first protrusion forming magnet insertion hole 711, the distance between the inner surface 621 of the second permanent magnet 62 and the inner wall portion 521 of the second magnet accommodating hole 52 is the first distance D21 in the second protrusion forming magnet insertion hole 712, and the distance between the inner surface 631 of the third permanent magnet 63 and the inner wall portion 531 of the third magnet accommodating hole 53 is the first distance D31 in the third protrusion forming magnet insertion hole 713. A plurality of the first protrusion forming magnet insertion holes 711, the second protrusion forming magnet insertion holes 712, and the third protrusion forming magnet insertion holes 713 are formed at equal intervals along the circumferential direction so as to correspond to the magnetic pole portions 30 of the rotor core 20. In the present embodiment, eight first protrusion forming magnet insertion holes 711, eight second protrusion forming magnet insertion holes 712, and eight third protrusion forming magnet insertion holes 713 are formed at equal intervals along the circumferential direction, that is, at intervals of 45 degrees.

The first protrusion forming magnet insertion hole 711 includes a first protrusion forming surface 7111 facing the inner surface 611 of the first permanent magnet 61 and forming the inner wall portion 511 of the first magnet accommodating hole 51, an outer wall portion forming surface 7112 facing the outer surface 612 of the first permanent magnet 61 and forming the outer wall portion 512 of the first magnet accommodating hole 51, a first end wall portion forming surface 7113a connecting an end portion of the first protrusion forming surface 7111 on one side in the circumferential direction and an end portion of the outer wall portion forming surface 7112 on one side in the circumferential direction to form the first end wall portion 513a of the first magnet accommodating hole 51, and a second end wall portion forming surface 7113b connecting an end portion of the first protrusion forming surface 7111 on the other side in the circumferential direction and an end portion of the outer wall portion forming surface 7112 on the other side in the circumferential direction to form the second end wall portion 513b of the first magnet accommodating hole 51.

The second protrusion forming magnet insertion hole 712 includes a second protrusion forming surface 7121 facing the inner surface 621 of the second permanent magnet 62 and forming the inner wall portion 521 of the second magnet accommodating hole 52, an outer wall portion forming surface 7122 facing the outer surface 622 of the second permanent magnet 62 and forming the outer wall portion 522 of the second magnet accommodating hole 52, a d-axis side wall portion forming surface 7123d connecting an end portion of the second protrusion forming surface 7121 on the d-axis side and an end portion of the outer wall portion forming surface 7122 on the d-axis side to form the d-axis side wall portion 523d of the second magnet accommodating hole 52, and a q-axis side wall portion forming surface 7123q connecting an end portion of the second protrusion forming surface 7121 on the q-axis side and an end portion of the outer wall portion forming surface 7122 on the q-axis side to form the q-axis side wall portion 523q of the second magnet accommodating hole 52.

The third protrusion forming magnet insertion hole 713 includes a third protrusion forming surface 7131 facing the inner surface 631 of the third permanent magnet 63 and forming the inner wall portion 531 of the third magnet accommodating hole 53, an outer wall portion forming surface 7132 facing the outer surface 632 of the third permanent magnet 63 and forming the outer wall portion 532 of the third magnet accommodating hole 53, a d-axis side wall portion forming surface 7133d connecting an end portion of the third protrusion forming surface 7131 on the d-axis side and an end portion of the outer wall portion forming surface 7132 on the d-axis side to form the d-axis side wall portion 533d of the third magnet accommodating hole 53, and a q-axis side wall portion forming surface 7133q connecting an end portion of the third protrusion forming surface 7131 on the q-axis side and an end portion of the outer wall portion forming surface 7132 on the q-axis side to form the q-axis side wall portion 533q of the third magnet accommodating hole 53.

As illustrated in FIG. 4B, the void forming magnet insertion holes 72 formed in the each magnetic pole portion forming portion 80 of the second electromagnetic steel sheet 42 includes a first void forming magnet insertion hole 721 overlapping in the axial direction to form the first magnet accommodating hole 51, a second void forming magnet insertion hole 722 overlapping in the axial direction to form the second magnet accommodating hole 52, and a third void forming magnet insertion hole 723 overlapping in the axial direction to form the third magnet accommodating hole 53. The distance between the inner surface 611 of the first permanent magnet 61 and the inner wall portion 511 of the first magnet accommodating hole 51 is the second distance D12 in the first void forming magnet insertion hole 721, the distance between the inner surface 621 of the second permanent magnet 62 and the inner wall portion 521 of the second magnet accommodating hole 52 is the second distance D22 in the second void forming magnet insertion hole 722, and the distance between the inner surface 631 of the third permanent magnet 63 and the inner wall portion 531 of the third magnet accommodating hole 53 is the second distance D32 in the third void forming magnet insertion hole 723. A plurality of the first void forming magnet insertion holes 721, the second void forming magnet insertion holes 722, and the third void forming magnet insertion holes 723 are formed at equal intervals along the circumferential direction so as to correspond to the magnetic pole portions 30 of the rotor core 20. In the present embodiment, eight first void forming magnet insertion holes 721, eight second void forming magnet insertion holes 722, and eight third void forming magnet insertion holes 723 are formed at equal intervals along the circumferential direction, that is, at intervals of 45 degrees.

The first void forming magnet insertion hole 721 includes a first void forming surface 7211 facing the inner surface 611 of the first permanent magnet 61 and forming the inner wall portion 511 of the first magnet accommodating hole 51, an outer wall portion forming surface 7212 facing the outer surface 612 of the first permanent magnet 61 and forming the outer wall portion 512 of the first magnet accommodating hole 51, a first end wall portion forming surface 7213a connecting an end portion of the first void forming surface 7211 on one side in the circumferential direction and an end portion of the outer wall portion forming surface 7212 on one side in the circumferential direction to form the first end wall portion 513a of the first magnet accommodating hole 51, and a second end wall portion forming surface 7213b connecting an end portion of the first void forming surface 7211 on the other side in the circumferential direction and an end portion of the outer wall portion forming surface 7212 on the other side in the circumferential direction to form the second end wall portion 513b of the first magnet accommodating hole 51.

The first void forming surface 7211 of the first void forming magnet insertion hole 721 extends to face the inner surface 611 of the first permanent magnet 61 at a position farther from the inner surface 611 of the first permanent magnet 61 than the first protrusion forming surface 7111 of the first protrusion forming magnet insertion hole 711 when viewed in the axial direction. The outer wall portion forming surface 7212, the first end wall portion forming surface 7213a, and the second end wall portion forming surface 7213b of the first void forming magnet insertion hole 721 extend so as to overlap with the outer wall portion forming surface 7112, the first end wall portion forming surface 7113a, and the second end wall portion forming surface 7113b of the first protrusion forming magnet insertion hole 711, respectively, when viewed in the axial direction.

The second void forming magnet insertion hole 722 includes a second void forming surface 7221 facing the inner surface 621 of the second permanent magnet 62 and forming the inner wall portion 521 of the second magnet accommodating hole 52, an outer wall portion forming surface 7222 facing the outer surface 622 of the second permanent magnet 62 and forming the outer wall portion 522 of the second magnet accommodating hole 52, a d-axis side wall portion forming surface 7223d connecting an end portion of the second void forming surface 7221 on the d-axis side and an end portion of the outer wall portion forming surface 7222 on the d-axis side to form the d-axis side wall portion 523d of the second magnet accommodating hole 52, and a q-axis side wall portion forming surface 7223q connecting an end portion of the second void forming surface 7221 on the q-axis side and an end portion of the outer wall portion forming surface 7222 on the q-axis side to form the q-axis side wall portion 523q of the second magnet accommodating hole 52.

The second void forming surface 7221 of the second void forming magnet insertion hole 722 extends to face the inner surface 621 of the second permanent magnet 62 at a position farther from the inner surface 621 of the second permanent magnet 62 than the second protrusion forming surface 7121 of the second protrusion forming magnet insertion hole 712 when viewed in the axial direction. The outer wall portion forming surface 7222, the d-axis side wall portion forming surface 7223d, and the q-axis side wall portion forming surface 7223q of the second void forming magnet insertion hole 722 extend so as to overlap with the outer wall portion forming surface 7122, the d-axis side wall portion forming surface 7123d, and the q-axis side wall portion forming surface 7123q of the second protrusion forming magnet insertion hole 712, respectively, when viewed in the axial direction.

The third void forming magnet insertion hole 723 includes a third void forming surface 7231 facing the inner surface 631 of the third permanent magnet 63 and forming the inner wall portion 531 of the third magnet accommodating hole 53, an outer wall portion forming surface 7232 facing the outer surface 632 of the third permanent magnet 63 and forming the outer wall portion 532 of the third magnet accommodating hole 53, a d-axis side wall portion forming surface 7233d connecting an end portion of the third void forming surface 7231 on the d-axis side and an end portion of the outer wall portion forming surface 7232 on the d-axis side to form the d-axis side wall portion 533d of the third magnet accommodating hole 53, and a q-axis side wall portion forming surface 7233q connecting an end portion of the third void forming surface 7231 on the q-axis side and an end portion of the outer wall portion forming surface 7232 on the q-axis side to form the q-axis side wall portion 533q of the third magnet accommodating hole 53.

The third void forming surface 7231 of the third void forming magnet insertion hole 723 extends to face the inner surface 631 of the third permanent magnet 63 at a position farther from the inner surface 631 of the third permanent magnet 63 than the third protrusion forming surface 7131 of the third protrusion forming magnet insertion hole 713 when viewed in the axial direction. The outer wall portion forming surface 7232, the d-axis side wall portion forming surface 7233d, and the q-axis side wall portion forming surface 7233q of the third void forming magnet insertion hole 723 extend so as to overlap with the outer wall portion forming surface 7132, the d-axis side wall portion forming surface 7133d, and the q-axis side wall portion forming surface 7133q of the third protrusion forming magnet insertion hole 713, respectively, when viewed in the axial direction.

The rotor core 20 is formed by laminating in the axial direction the first electromagnetic steel sheet 41 in which the protrusion forming magnet insertion hole 71 is formed and the second electromagnetic steel sheet 42 in which the void forming magnet insertion hole 72 is formed in this manner. When the first electromagnetic steel sheet 41 and the second electromagnetic steel sheet 42 are laminated in the axial direction, the protrusion forming magnet insertion holes 71 and the void forming magnet insertion holes 72 are respectively laminated so as to overlap in the axial direction, and thus the magnet accommodating holes 50 are formed in the magnetic pole portions 30 of the rotor core 20. More specifically, when the first electromagnetic steel sheet 41 and the second electromagnetic steel sheet 42 are laminated in the axial direction, the first protrusion forming magnet insertion hole 711 and the first void forming magnet insertion hole 721 are laminated in the axial direction, the second protrusion forming magnet insertion hole 712 and the second void forming magnet insertion hole 722 are laminated in the axial direction, and the third protrusion forming magnet insertion hole 713 and the third void forming magnet insertion hole 723 are laminated in the axial direction. Accordingly, the first magnet accommodating hole 51, the second magnet accommodating hole 52, and the third magnet accommodating hole 53 are formed in the rotor core 20.

In the inner wall portion 511 of the first magnet accommodating hole 51, due to a difference in distance from the inner surface 611 of the first permanent magnet 61 between the first protrusion forming surface 7111 of the first protrusion forming magnet insertion hole 711 and the first void forming surface 7211 of the first void forming magnet insertion hole 721, the first protrusion forming surface 7111 of the first protrusion forming magnet insertion hole 711 protrudes from the first void forming surface 7211 of the first void forming magnet insertion hole 721 toward the inner surface 611 of the first permanent magnet 61 to form each of the plurality of first protrusions 510a formed along the axial direction. The plurality of first voids 510b are formed between the adjacent first protrusions 510a along the axial direction. In this way, the first low saturation magnetic flux density portion 510 is formed. Therefore, the first protrusion forming magnet insertion hole 711 forms the first protrusion 510a of the first low saturation magnetic flux density portion 510, and the first void forming magnet insertion hole 721 forms the first void 510b of the first low saturation magnetic flux density portion 510.

In this way, the first low saturation magnetic flux density portion 510 is formed by overlapping the first protrusion forming magnet insertion hole 711 and the first void forming magnet insertion hole 721 in the axial direction by laminating in the axial direction the first electromagnetic steel sheet 41 in which the first protrusion forming magnet insertion hole 711 is formed and the second electromagnetic steel sheet 42 in which the first void forming magnet insertion hole 721 is formed.

Therefore, the first low saturation magnetic flux density portion 510 can be formed simply by overlapping the first protrusion forming magnet insertion hole 711 and the first void forming magnet insertion hole 721 in the axial direction, so that the first low saturation magnetic flux density portion 510 can be easily formed.

In the present embodiment, the first low saturation magnetic flux density portion 510 can be formed simply by laminating in the axial direction the first electromagnetic steel sheet 41 in which the first protrusion forming magnet insertion hole 711 is formed and the second electromagnetic steel sheet 42 in which the first void forming magnet insertion hole 721 having the first void forming surface 7211 whose radial distance from the inner surface 611 of the first permanent magnet 61 is different from that of the first protrusion forming surface 7111 of the first protrusion forming magnet insertion hole 711 is formed. Accordingly, the first low saturation magnetic flux density portion 510 can be formed simply by preparing two types of electromagnetic steel sheets 40 and laminating the electromagnetic steel sheets 40 in the axial direction, and thus the first low saturation magnetic flux density portion 510 can be formed easily at low cost.

In the inner wall portion 521 of the second magnet accommodating hole 52, due to a difference in distance from the inner surface 621 of the second permanent magnet 62 between the second protrusion forming surface 7121 of the second protrusion forming magnet insertion hole 712 and the second void forming surface 7221 of the second void forming magnet insertion hole 722, the second protrusion forming surface 7121 of the second protrusion forming magnet insertion hole 712 protrudes from the second void forming surface 7221 of the second void forming magnet insertion hole 722 toward the inner surface 621 of the second permanent magnet 62 to form each of the plurality of second protrusions 520a formed along the axial direction. The plurality of second voids 520b are formed between the adjacent second protrusions 520a along the axial direction. In this way, the second low saturation magnetic flux density portion 520 is formed. Therefore, the second protrusion forming magnet insertion hole 712 forms the second protrusion 520a of the second low saturation magnetic flux density portion 520, and the second void forming magnet insertion hole 722 forms the second void 520b of the second low saturation magnetic flux density portion 520.

In this way, the second low saturation magnetic flux density portion 520 is formed by overlapping the second protrusion forming magnet insertion hole 712 and the second void forming magnet insertion hole 722 in the axial direction by laminating in the axial direction the first electromagnetic steel sheet 41 in which the second protrusion forming magnet insertion hole 712 is formed and the second electromagnetic steel sheet 42 in which the second void forming magnet insertion hole 722 is formed.

Therefore, the second low saturation magnetic flux density portion 520 can be formed simply by overlapping the second protrusion forming magnet insertion hole 712 and the second void forming magnet insertion hole 722 in the axial direction, so that the second low saturation magnetic flux density portion 520 can be easily formed.

In the present embodiment, the second low saturation magnetic flux density portion 520 can be formed simply by laminating in the axial direction the first electromagnetic steel sheet 41 in which the second protrusion forming magnet insertion hole 712 is formed and the second electromagnetic steel sheet 42 in which the second void forming magnet insertion hole 722 having the second void forming surface 7221 whose radial distance from the inner surface 621 of the second permanent magnet 62 is different from that of the second protrusion forming surface 7121 of the second protrusion forming magnet insertion hole 712 is formed. Accordingly, the second low saturation magnetic flux density portion 520 can be formed simply by preparing two types of electromagnetic steel sheets 40 and laminating the electromagnetic steel sheets 40 in the axial direction, and thus the second low saturation magnetic flux density portion 520 can be formed easily at low cost.

In the inner wall portion 531 of the third magnet accommodating hole 53, due to a difference in distance from the inner surface 631 of the third permanent magnet 63 between the third protrusion forming surface 7131 of the third protrusion forming magnet insertion hole 713 and the third void forming surface 7231 of the third void forming magnet insertion hole 723, the third protrusion forming surface 7131 of the third protrusion forming magnet insertion hole 713 protrudes from the third void forming surface 7231 of the third void forming magnet insertion hole 723 toward the inner surface 631 of the third permanent magnet 63 to form each of the plurality of third protrusions 530a formed along the axial direction. The plurality of third voids 530b are formed between the adjacent third protrusions 530a along the axial direction. In this way, the third low saturation magnetic flux density portion 530 is formed. Therefore, the third protrusion forming magnet insertion hole 713 forms the third protrusion 530a of the third low saturation magnetic flux density portion 530, and the third void forming magnet insertion hole 723 forms the third void 530b of the third low saturation magnetic flux density portion 530.

In this way, the third low saturation magnetic flux density portion 530 is formed by overlapping the third protrusion forming magnet insertion hole 713 and the third void forming magnet insertion hole 723 in the axial direction by laminating in the axial direction the first electromagnetic steel sheet 41 in which the third protrusion forming magnet insertion hole 713 is formed and the second electromagnetic steel sheet 42 in which the third void forming magnet insertion hole 723 is formed.

Therefore, the third low saturation magnetic flux density portion 530 can be formed simply by overlapping the third protrusion forming magnet insertion hole 713 and the third void forming magnet insertion hole 723 in the axial direction, so that the third low saturation magnetic flux density portion 530 can be easily formed.

In the present embodiment, the third low saturation magnetic flux density portion 530 can be formed simply by laminating in the axial direction the first electromagnetic steel sheet 41 in which the third protrusion forming magnet insertion hole 713 is formed and the second electromagnetic steel sheet 42 in which the third void forming magnet insertion hole 723 having the third void forming surface 7231 whose radial distance from the inner surface 631 of the third permanent magnet 63 is different from that of the third protrusion forming surface 7131 of the third protrusion forming magnet insertion hole 713 is formed. Accordingly, the third low saturation magnetic flux density portion 530 can be formed simply by preparing two types of electromagnetic steel sheets 40 and laminating the electromagnetic steel sheets 40 in the axial direction, and thus the third low saturation magnetic flux density portion 530 can be formed easily at low cost.

<Maximum Output Torque-Loss During No-Load Operation Characteristics>

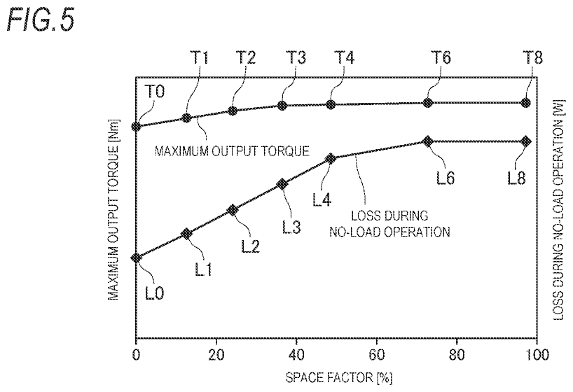

Next, with reference to FIG. 5, maximum output torque-loss during no-load operation characteristics of the rotary electric machine 1 in a case where the first low saturation magnetic flux density portion 510, the second low saturation magnetic flux density portion 520, and the third low saturation magnetic flux density portion 530 are formed will be described.

FIG. 5 is a graph illustrating the maximum output torque-loss during no-load operation characteristics when a ratio of the protrusion forming magnet insertion holes 71 to the void forming magnet insertion holes 72, which are overlapped with each other, is changed in the magnet accommodating hole 50 formed by overlapping the protrusion forming magnet insertion holes 71 and the void forming magnet insertion holes 72 in the axial direction. A ratio of the first protrusions 510a, the second protrusions 520a, and the third protrusions 530a respectively in the first low saturation magnetic flux density portion 510, the second low saturation magnetic flux density portion 520, and the third low saturation magnetic flux density portion 530 may be referred to as a space factor.

A maximum output torque T0 illustrated in FIG. 5 is the maximum output torque of the rotary electric machine 1 in a case where the magnet accommodating hole 50 is formed by overlapping only the void forming magnet insertion holes 72. More specifically, the maximum output torque T0 is the maximum output torque of the rotary electric machine 1 in a case where the first magnet accommodating hole 51 is formed by overlapping only the first void forming magnet insertion hole 721, the second magnet accommodating hole 52 is formed by overlapping only the second void forming magnet insertion hole 722, and the third magnet accommodating hole 53 is formed by overlapping only the third void forming magnet insertion hole 723.

A maximum output torque T1 is the maximum output torque of the rotary electric machine 1 in a case where the magnet insertion holes 70 are overlapped such that 1/8 is a ratio of the protrusion forming magnet insertion holes 71 and 7/8 is a ratio of the void forming magnet insertion holes 72. More specifically, the maximum output torque T1 is the maximum output torque of the rotary electric machine 1 in a case where the first magnet accommodating hole 51 is formed by overlapping the first protrusion forming magnet insertion holes 711 and the first void forming magnet insertion holes 721 such that 1/8 is a ratio of the first protrusion forming magnet insertion holes 711 and 7/8 is a ratio of the first void forming magnet insertion holes 721, the second magnet accommodating hole 52 is formed by overlapping the second protrusion forming magnet insertion holes 712 and the second void forming magnet insertion holes 722 such that 1/8 is a ratio of the second protrusion forming magnet insertion holes 712 and 7/8 is a ratio of the second void forming magnet insertion holes 722, and the third magnet accommodating hole 53 is formed by overlapping the third protrusion forming magnet insertion holes 713 and the third void forming magnet insertion holes 723 such that 1/8 is a ratio of the third protrusion forming magnet insertion holes 713 and 7/8 is a ratio of the third void forming magnet insertion holes 723. In this case, the first low saturation magnetic flux density portion 510 is formed such that 1/8 is a ratio of the first protrusions 510a and 7/8 is a ratio of the first voids 510b, the second low saturation magnetic flux density portion 520 is formed such that 1/8 is a ratio of the second protrusions 520a and 7/8 is a ratio of the second voids 520b, and the third low saturation magnetic flux density portion 530 is formed such that 1/8 is a ratio of the third protrusions 530a and 7/8 is a ratio of the third voids 530b.

A maximum output torque T2 is the maximum output torque of the rotary electric machine 1 in a case where the magnet insertion holes 70 are overlapped such that 2/8 is a ratio of the protrusion forming magnet insertion holes 71 and 6/8 is a ratio of the void forming magnet insertion holes 72. More specifically, the maximum output torque T2 is the maximum output torque of the rotary electric machine 1 in a case where the first magnet accommodating hole 51 is formed by overlapping the first protrusion forming magnet insertion holes 711 and the first void forming magnet insertion holes 721 such that 2/8 is a ratio of the first protrusion forming magnet insertion holes 711 and 6/8 is a ratio of the first void forming magnet insertion holes 721, the second magnet accommodating hole 52 is formed by overlapping the second protrusion forming magnet insertion holes 712 and the second void forming magnet insertion holes 722 such that 2/8 is a ratio of the second protrusion forming magnet insertion holes 712 and 6/8 is a ratio of the second void forming magnet insertion holes 722, and the third magnet accommodating hole 53 is formed by overlapping the third protrusion forming magnet insertion holes 713 and the third void forming magnet insertion holes 723 such that 2/8 is a ratio of the third protrusion forming magnet insertion holes 713 and 6/8 is a ratio of the third void forming magnet insertion holes 723. In this case, the first low saturation magnetic flux density portion 510 is formed such that 2/8 is a ratio of the first protrusions 510a and 6/8 is a ratio of the first voids 510b, the second low saturation magnetic flux density portion 520 is formed such that 2/8 is a ratio of the second protrusions 520a and 6/8 is a ratio of the second voids 520b, and the third low saturation magnetic flux density portion 530 is formed such that 2/8 is a ratio of the third protrusions 530a and 6/8 is a ratio of the third voids 530b.

A maximum output torque T3 is the maximum output torque of the rotary electric machine 1 in a case where the magnet insertion holes 70 are overlapped such that 3/8 is a ratio of the protrusion forming magnet insertion holes 71 and 5/8 is a ratio of the void forming magnet insertion holes 72. More specifically, the maximum output torque 13 is the maximum output torque of the rotary electric machine 1 in a case where the first magnet accommodating hole 51 is formed by overlapping the first protrusion forming magnet insertion holes 711 and the first void forming magnet insertion holes 721 such that 3/8 is a ratio of the first protrusion forming magnet insertion holes 711 and 5/8 is a ratio of the first void forming magnet insertion holes 721, the second magnet accommodating hole 52 is formed by overlapping the second protrusion forming magnet insertion holes 712 and the second void forming magnet insertion holes 722 such that 3/8 is a ratio of the second protrusion forming magnet insertion holes 712 and 5/8 is a ratio of the second void forming magnet insertion holes 722, and the third magnet accommodating hole 53 is formed by overlapping the third protrusion forming magnet insertion holes 713 and the third void forming magnet insertion holes 723 such that 3/8 is a ratio of the third protrusion forming magnet insertion holes 713 and 5/8 is a ratio of the third void forming magnet insertion holes 723. In this case, the first low saturation magnetic flux density portion 510 is formed such that 3/8 is a ratio of the first protrusions 510a and 5/8 is a ratio of the first voids 510b, the second low saturation magnetic flux density portion 520 is formed such that 3/8 is a ratio of the second protrusions 520a and 5/8 is a ratio of the second voids 520b, and the third low saturation magnetic flux density portion 530 is formed such that 3/8 is a ratio of the third protrusions 530a and 5/8 is a ratio of the third voids 530b.

A maximum output torque T4 is the maximum output torque of the rotary electric machine 1 in a case where the magnet insertion holes 70 are overlapped such that 4/8 is a ratio of the protrusion forming magnet insertion holes 71 and 4/8 is a ratio of the void forming magnet insertion holes 72. More specifically, the maximum output torque T4 is the maximum output torque of the rotary electric machine 1 in a case where the first magnet accommodating hole 51 is formed by overlapping the first protrusion forming magnet insertion holes 711 and the first void forming magnet insertion holes 721 such that 4/8 is a ratio of the first protrusion forming magnet insertion holes 711 and 4/8 is a ratio of the first void forming magnet insertion holes 721, the second magnet accommodating hole 52 is formed by overlapping the second protrusion forming magnet insertion holes 712 and the second void forming magnet insertion holes 722 such that 4/8 is a ratio of the second protrusion forming magnet insertion holes 712 and 4/8 is a ratio of the second void forming magnet insertion holes 722, and the third magnet accommodating hole 53 is formed by overlapping the third protrusion forming magnet insertion holes 713 and the third void forming magnet insertion holes 723 such that 4/8 is a ratio of the third protrusion forming magnet insertion holes 713 and 4/8 is a ratio of the third void forming magnet insertion holes 723. In this case, the first low saturation magnetic flux density portion 510 is formed such that 4/8 is a ratio of the first protrusions 510a and 4/8 is a ratio of the first voids 510b, the second low saturation magnetic flux density portion 520 is formed such that 4/8 is a ratio of the second protrusions 520a and 4/8 is a ratio of the second voids 520b, and the third low saturation magnetic flux density portion 530 is formed such that 4/8 is a ratio of the third protrusions 530a and 4/8 is a ratio of the third voids 530b.

A maximum output torque T6 is the maximum output torque of the rotary electric machine 1 in a case where the magnet insertion holes 70 are overlapped such that 6/8 is a ratio of the protrusion forming magnet insertion holes 71 and 2/8 is a ratio of the void forming magnet insertion holes 72. More specifically, the maximum output torque T6 is the maximum output torque of the rotary electric machine 1 in a case where the first magnet accommodating hole 51 is formed by overlapping the first protrusion forming magnet insertion holes 711 and the first void forming magnet insertion holes 721 such that 6/8 is a ratio of the first protrusion forming magnet insertion holes 711 and 2/8 is a ratio of the first void forming magnet insertion holes 721, the second magnet accommodating hole 52 is formed by overlapping the second protrusion forming magnet insertion holes 712 and the second void forming magnet insertion holes 722 such that 6/8 is a ratio of the second protrusion forming magnet insertion holes 712 and 2/8 is a ratio of the second void forming magnet insertion holes 722, and the third magnet accommodating hole 53 is formed by overlapping the third protrusion forming magnet insertion holes 713 and the third void forming magnet insertion holes 723 such that 6/8 is a ratio of the third protrusion forming magnet insertion holes 713 and 2/8 is a ratio of the third void forming magnet insertion holes 723. In this case, the first low saturation magnetic flux density portion 510 is formed such that 6/8 is a ratio of the first protrusions 510a and 2/8 is a ratio of the first voids 510b, the second low saturation magnetic flux density portion 520 is formed such that 6/8 is a ratio of the second protrusions 520a and 2/8 is a ratio of the second voids 520b, and the third low saturation magnetic flux density portion 530 is formed such that 6/8 is a ratio of the third protrusions 530a and 2/8 is a ratio of the third voids 530b.

A maximum output torque T8 is the maximum output torque of the rotary electric machine 1 in a case where the magnet accommodating hole 50 is formed by overlapping only the protrusion forming magnet insertion holes 71. More specifically, the maximum output torque T8 is the maximum output torque of the rotary electric machine 1 in a case where the first magnet accommodating hole 51 is formed by overlapping only the first protrusion forming magnet insertion holes 711, the second magnet accommodating hole 52 is formed by overlapping only the second protrusion forming magnet insertion holes 712, and the third magnet accommodating hole 53 is formed by overlapping only the third protrusion forming magnet insertion holes 713. In this case, the first low saturation magnetic flux density portion 510 is not formed.

A no-load loss L0 illustrated in FIG. 5 is a loss which occurs during no-load operation of the rotary electric machine 1 in a case where the magnet accommodating hole 50 is formed by overlapping only the void forming magnet insertion holes 72. More specifically, the no-load loss L0 is a loss that occurs during no-load operation of the rotary electric machine 1 in a case where the first magnet accommodating hole 51 is formed by overlapping only the first void forming magnet insertion holes 721, the second magnet accommodating hole 52 is formed by overlapping only the second void forming magnet insertion holes 722, and the third magnet accommodating hole 53 is formed by overlapping only the third void forming magnet insertion holes 723.

A no-load loss L1 is a loss which occurs during no-load operation of the rotary electric machine 1 in a case where the magnet insertion holes 70 are overlapped such that 1/8 is a ratio of the protrusion forming magnet insertion holes 71 and 7/8 is a ratio of the void forming magnet insertion holes 72. More specifically, the no-load loss L1 is a loss that occurs during no-load operation of the rotary electric machine 1 in a case where the first magnet accommodating hole 51 is formed by overlapping the first protrusion forming magnet insertion holes 711 and the first void forming magnet insertion holes 721 such that 1/8 is a ratio of the first protrusion forming magnet insertion holes 711 and 7/8 is a ratio of the first void forming magnet insertion hole 721, the second magnet accommodating hole 52 is formed by overlapping the second protrusion forming magnet insertion holes 712 and the second void forming magnet insertion holes 722 such that 1/8 is a ratio of the second protrusion forming magnet insertion holes 712 and 7/8 is a ratio of the second void forming magnet insertion holes 722, and the third magnet accommodating hole 53 is formed by overlapping the third protrusion forming magnet insertion holes 713 and the third void forming magnet insertion holes 723 such that 1/8 is a ratio of the third protrusion forming magnet insertion holes 713 and 7/8 is a ratio of the third void forming magnet insertion holes 723. In this case, the first low saturation magnetic flux density portion 510 is formed such that 1/8 is a ratio of the first protrusions 510a and 7/8 is a ratio of the first voids 510b, the second low saturation magnetic flux density portion 520 is formed such that 1/8 is a ratio of the second protrusions 520a and 7/8 is a ratio of the second voids 520b, and the third low saturation magnetic flux density portion 530 is formed such that 1/8 is a ratio of the third protrusions 530a and 7/8 is a ratio of the third voids 530b.

The no-load loss L2 is a loss which occurs during no-load operation of the rotary electric machine 1 in a case where the magnet insertion holes 70 are overlapped such that 2/8 is a ratio of the protrusion forming magnet insertion holes 71 and 6/8 is a ratio of the void forming magnet insertion holes 72. More specifically, the no-load loss L2 is a loss that occurs during no-load operation of the rotary electric machine 1 in a case where the first magnet accommodating hole 51 is formed by overlapping the first protrusion forming magnet insertion holes 711 and the first void forming magnet insertion holes 721 such that 2/8 is a ratio of the first protrusion forming magnet insertion holes 711 and 6/8 is a ratio of the first void forming magnet insertion holes 721, the second magnet accommodating hole 52 is formed by overlapping the second protrusion forming magnet insertion holes 712 and the second void forming magnet insertion holes 722 such that 2/8 is a ratio of the second protrusion forming magnet insertion holes 712 and 6/8 is a ratio of the second void forming magnet insertion holes 722, and the third magnet accommodating hole 53 is formed by overlapping the third protrusion forming magnet insertion holes 713 and the third void forming magnet insertion holes 723 such that 2/8 is a ratio of the third protrusion forming magnet insertion holes 713 and 6/8 is a ratio of the third void forming magnet insertion holes 723. In this case, the first low saturation magnetic flux density portion 510 is formed such that 2/8 is a ratio of the first protrusions 510a and 6/8 is a ratio of the first voids 510b, the second low saturation magnetic flux density portion 520 is formed such that 2/8 is a ratio of the second protrusions 520a and 6/8 is a ratio of the second voids 520b, and the third low saturation magnetic flux density portion 530 is formed such that 2/8 is a ratio of the third protrusions 530a and 6/8 is a ratio of the third voids 530b.

A no-load loss L3 is a loss which occurs during no-load operation of the rotary electric machine 1 in a case where the magnet insertion holes 70 are overlapped such that 3/8 is a ratio of the protrusion forming magnet insertion holes 71 and 5/8 is a ratio of the void forming magnet insertion holes 72. More specifically, the no-load loss L3 is a loss that occurs during no-load operation of the rotary electric machine 1 in a case where the first magnet accommodating hole 51 is formed by overlapping the first protrusion forming magnet insertion holes 711 and the first void forming magnet insertion holes 721 such that 3/8 is a ratio of the first protrusion forming magnet insertion holes 711 and 5/8 is a ratio of the first void forming magnet insertion holes 721, the second magnet accommodating hole 52 is formed by overlapping the second protrusion forming magnet insertion holes 712 and the second void forming magnet insertion holes 722 such that 3/8 is a ratio of the second protrusion forming magnet insertion holes 712 and 5/8 is a ratio of the second void forming magnet insertion holes 722, and the third magnet accommodating hole 53 is formed by overlapping the third protrusion forming magnet insertion holes 713 and the third void forming magnet insertion holes 723 such that 3/8 is a ratio of the third protrusion forming magnet insertion holes 713 and 5/8 is a ratio of the third void forming magnet insertion holes 723. In this case, the first low saturation magnetic flux density portion 510 is formed such that 3/8 is a ratio of the first protrusions 510a and 5/8 is a ratio of the first voids 510b, the second low saturation magnetic flux density portion 520 is formed such that 3/8 is a ratio of the second protrusions 520a and 5/8 is a ratio of the second voids 520b, and the third low saturation magnetic flux density portion 530 is formed such that 3/8 is a ratio of the third protrusions 530a and 5/8 is a ratio of the third voids 530b.

A no-load loss L4 is a loss which occurs during no-load operation of the rotary electric machine 1 in a case where the magnet insertion holes 70 are overlapped such that 4/8 is a ratio of the protrusion forming magnet insertion holes 71 and 4/8 is a ratio of the void forming magnet insertion holes 72. More specifically, the no-load loss L4 is a loss which occurs during no-load operation of the rotary electric machine 1 in a case where the first magnet accommodating hole 51 is formed by overlapping the first protrusion forming magnet insertion holes 711 and the first void forming magnet insertion holes 721 such that 4/8 is a ratio of the first protrusion forming magnet insertion holes 711 and 4/8 is a ratio of the first void forming magnet insertion holes 721, the second magnet accommodating hole 52 is formed by overlapping the second protrusion forming magnet insertion holes 712 and the second void forming magnet insertion holes 722 such that 4/8 is a ratio of the second protrusion forming magnet insertion holes 712 and 4/8 is a ratio of the second void forming magnet insertion holes 722, and the third magnet accommodating hole 53 is formed by overlapping the third protrusion forming magnet insertion holes 713 and the third void forming magnet insertion holes 723 such that 4/8 is a ratio of the third protrusion forming magnet insertion holes 713 and 4/8 is a ratio of the third void forming magnet insertion holes 723. In this case, the first low saturation magnetic flux density portion 510 is formed such that 4/8 is a ratio of the first protrusions 510a and 4/8 is a ratio of the first voids 510b, the second low saturation magnetic flux density portion 520 is formed such that 4/8 is a ratio of the second protrusions 520a and 4/8 is a ratio of the second voids 520b, and the third low saturation magnetic flux density portion 530 is formed such that 4/8 is a ratio of the third protrusions 530a and 4/8 is a ratio of the third voids 530b.

A no-load loss L6 is a loss which occurs during no-load operation of the rotary electric machine 1 in a case where the magnet insertion holes 70 are overlapped such that 6/8 is a ratio of the protrusion forming magnet insertion holes 71 and 2/8 is a ratio of the void forming magnet insertion holes 72. More specifically, the no-load loss L6 is a loss which occurs during no-load operation of the rotary electric machine 1 in a case where the first magnet accommodating hole 51 is formed by overlapping the first protrusion forming magnet insertion holes 711 and the first void forming magnet insertion holes 721 such that 6/8 is a ratio of the first protrusion forming magnet insertion holes 711 and 2/8 is a ratio of the first void forming magnet insertion holes 721, the second magnet accommodating hole 52 is formed by overlapping the second protrusion forming magnet insertion holes 712 and the second void forming magnet insertion holes 722 such that 6/8 is a ratio of the second protrusion forming magnet insertion holes 712 and 2/8 is a ratio of the second void forming magnet insertion holes 722, and the third magnet accommodating hole 53 is formed by overlapping the third protrusion forming magnet insertion holes 713 and the third void forming magnet insertion holes 723 such that 6/8 is a ratio of the third protrusion forming magnet insertion holes 713 and 2/8 is a ratio of the third void forming magnet insertion holes 723. In this case, the first low saturation magnetic flux density portion 510 is formed such that 6/8 is a ratio of the first protrusions 510a and 2/8 is a ratio of the first voids 510b, the second low saturation magnetic flux density portion 520 is formed such that 6/8 is a ratio of the second protrusions 520a and 2/8 is a ratio of the second voids 520b, and the third low saturation magnetic flux density portion 530 is formed such that 6/8 is a ratio of the third protrusions 530a and 2/8 is a ratio of the third voids 530b.

A no-load loss L8 is a loss which occurs during no-load operation of the rotary electric machine 1 in a case where the magnet accommodating hole 50 is formed by overlapping only the protrusion forming magnet insertion holes 71. More specifically, the maximum output torque T8 is a loss which occurs during no-load operation of the rotary electric machine 1 in a case where the first magnet accommodating hole 51 is formed by overlapping only the first protrusion forming magnet insertion holes 711, the second magnet accommodating hole 52 is formed by overlapping only the second protrusion forming magnet insertion holes 712, and the third magnet accommodating hole 53 is formed by overlapping only the third protrusion forming magnet insertion holes 713. In this case, the first low saturation magnetic flux density portion 510 is not formed.

As illustrated in FIG. 5, when a ratio of the first protrusions 510a to the first voids 510b in the first low saturation magnetic flux density portion 510, a ratio of the second protrusions 520a to the second voids 520b in the second low saturation magnetic flux density portion 520, and a ratio of the third protrusions 530a to the third voids 530b in the third low saturation magnetic flux density portion 530 are from (protrusion):(void)=2 6 to (protrusion):(void)=4:4, that is, when a ratio of the first protrusions 510a in the first low saturation magnetic flux density portion 510, a ratio of the second protrusions 520a in the second low saturation magnetic flux density portion 520, and a ratio of the third protrusions 530a in the third low saturation magnetic flux density portion 530 are 25% or higher and 50% or lower, it is possible to reduce the loss during no-load operation of the rotary electric machine 1 while maintaining the maximum output torque of the rotary electric machine 1. More preferably, when a ratio of the first protrusions 510a to the first voids 510b in the first low saturation magnetic flux density portion 510, a ratio of the second protrusions 520a to the second voids 520b in the second low saturation magnetic flux density portion 520, and a ratio of the third protrusions 530a to the third voids 530b in the third low saturation magnetic flux density portion 530 are close to (protrusion):(void)=3:5, that is, when a ratio of the first protrusions 510a in the first low saturation magnetic flux density portion 510, a ratio of the second protrusions 520a in the second low saturation magnetic flux density portion 520, and a ratio of the third protrusions 530a in the third low saturation magnetic flux density portion 530 are 35% or higher and 40% or lower, it is possible to reduce the loss during no-load operation of the rotary electric machine 1 while maintaining the maximum output torque of the rotary electric machine 1.

### Second Embodiment

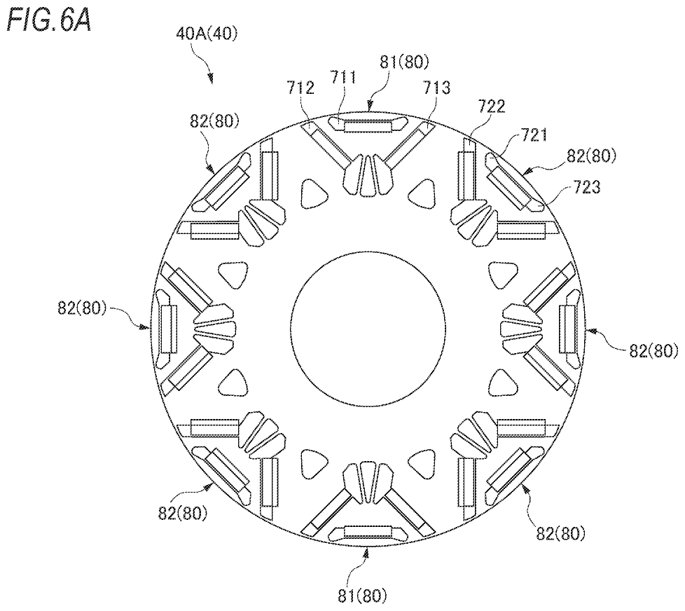

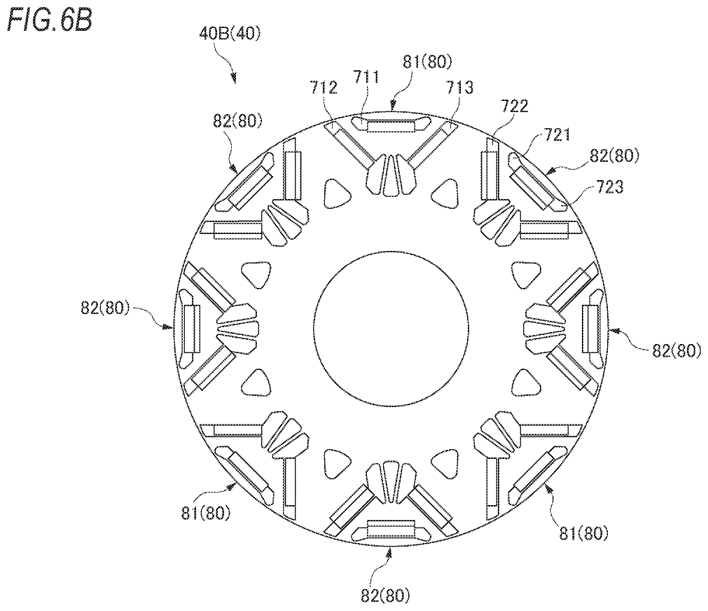

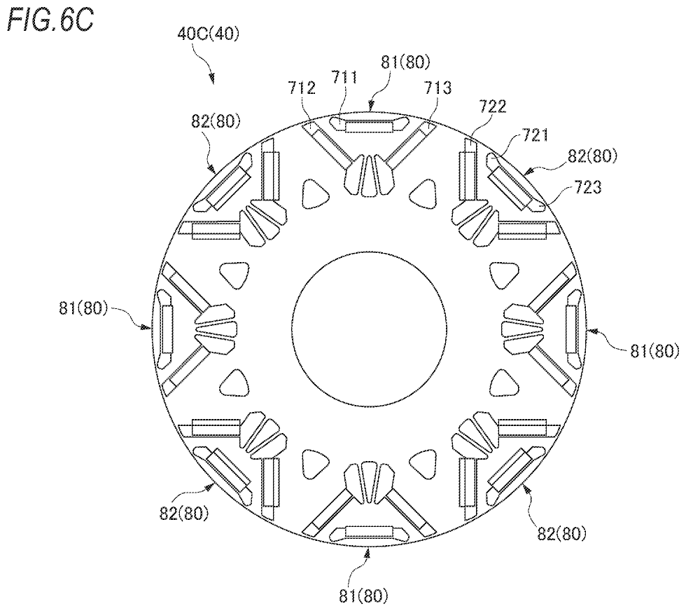

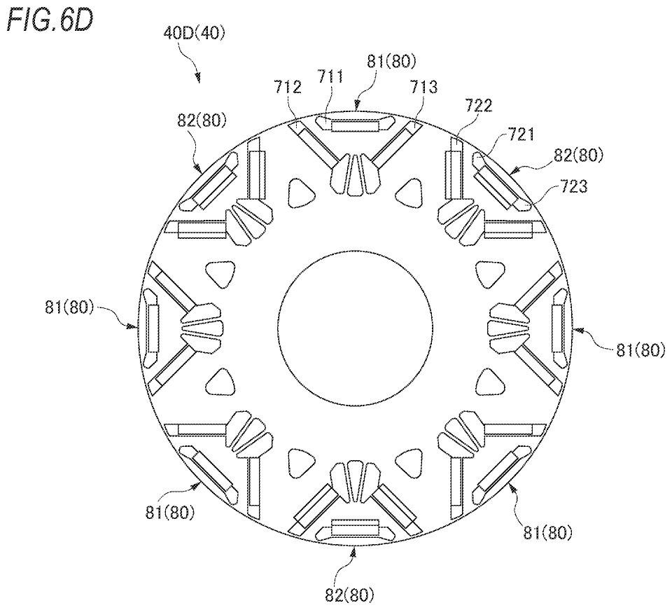

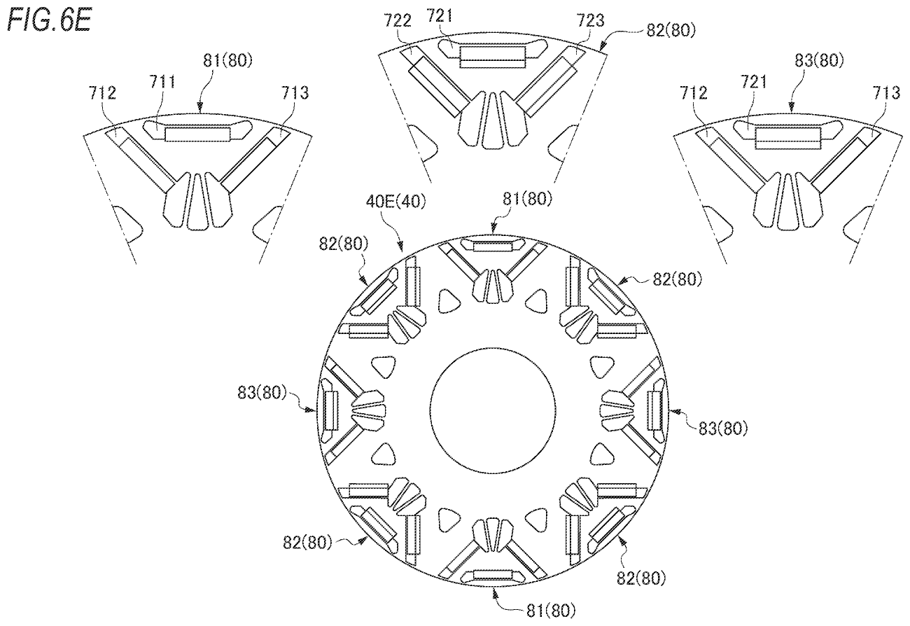

Next, the rotor 10 for a rotary electric machine according to a second embodiment of the present invention will be described with reference to FIGS. 6A to 6E. In the following description, the same components as those of the rotor 10 for the rotary electric machine according to the first embodiment are denoted by the same reference numerals, and description thereof will be omitted or simplified. In the rotor 10 for the rotary electric machine according to the first embodiment, the electromagnetic steel sheet 40 includes the first electromagnetic steel sheet 41 in which the protrusion forming magnet insertion hole 71 is formed and the second electromagnetic steel sheet 42 in which the void forming magnet insertion hole 72 is formed, but in the rotor 10 for the rotary electric machine according to the second embodiment, both the protrusion forming magnet insertion hole 71 and the void forming magnet insertion hole 72 are formed in each electromagnetic steel sheet 40. Hereinafter, differences between the rotor 10 for the rotary electric machine according to the first embodiment and the rotor 10 for the rotary electric machine according to the second embodiment will be described in detail.

<Electromagnetic Steel Sheet>

The magnet insertion hole 70 formed in the electromagnetic steel sheet 40 includes the protrusion forming magnet insertion hole 71 and the void forming magnet insertion hole 72. In the present embodiment, both the protrusion forming magnet insertion hole 71 and the void forming magnet insertion hole 72 are formed in each electromagnetic steel sheet 40. Hereinafter, an electromagnetic steel sheet 40A according to a first example, an electromagnetic steel sheet 40B according to a second example, an electromagnetic steel sheet 40C according to a third example, an electromagnetic steel sheet 40D according to a fourth example, and an electromagnetic steel sheet 40E according to a fifth example of the present embodiment will be described.

### First Example

As illustrated in FIG. 6A, the electromagnetic steel sheet 40A according to the first example of the present embodiment includes a plurality of magnetic pole portion forming portions 80 formed along a circumferential direction. The plurality of magnetic pole portion forming portions 80 are formed at equal intervals along the circumferential direction. In the present embodiment, eight magnetic pole portion forming portions 80 are formed at equal intervals along the circumferential direction, that is, at intervals of 45 degrees.

The magnetic pole portion forming portion 80 of the electromagnetic steel sheet 40A includes a first magnetic pole portion forming portion 81 and a second magnetic pole portion forming portion 82.

The first magnetic pole portion forming portion 81 is provided with the first protrusion forming magnet insertion hole 711 overlapping in an axial direction to form the first magnet accommodating hole 51, the second protrusion forming magnet insertion hole 712 overlapping in the axial direction to form the second magnet accommodating hole 52, and the third protrusion forming magnet insertion hole 713 overlapping in the axial direction to form the third magnet accommodating hole 53. A distance between the inner surface 611 of the first permanent magnet 61 and the inner wall portion 511 of the first magnet accommodating hole 51 is the first distance D11 in the first protrusion forming magnet insertion hole 711, a distance between the inner surface 621 of the second permanent magnet 62 and the inner wall portion 521 of the second magnet accommodating hole 52 is the first distance D21 in the second protrusion forming magnet insertion hole 712, and a distance between the inner surface 631 of the third permanent magnet 63 and the inner wall portion 531 of the third magnet accommodating hole 53 is the first distance D31 in the third protrusion forming magnet insertion hole 713.

The second magnetic pole portion forming portion 82 is provided with the first void forming magnet insertion hole 721 overlapping in the axial direction to form the first magnet accommodating hole 51, the second void forming magnet insertion hole 722 overlapping in the axial direction to form the second magnet accommodating hole 52, and the third void forming magnet insertion hole 723 overlapping in the axial direction to form the third magnet accommodating hole 53. A distance between the inner surface 611 of the first permanent magnet 61 and the inner wall portion 511 of the first magnet accommodating hole 51 is the second distance D12 in the first void forming magnet insertion hole 721, a distance between the inner surface 621 of the second permanent magnet 62 and the inner wall portion 521 of the second magnet accommodating hole 52 is the second distance D22 in the second void forming magnet insertion hole 722, and a distance between the inner surface 631 of the third permanent magnet 63 and the inner wall portion 531 of the third magnet accommodating hole 53 is the second distance D32 in the third void forming magnet insertion hole 723.

In the electromagnetic steel sheet 40A according to the first example of the present embodiment, eight magnetic pole portion forming portions 80 are formed at equal intervals along the circumferential direction in an order of the first magnetic pole portion forming portion 81, the second magnetic pole portion forming portion 82, the second magnetic pole portion forming portion 82, the second magnetic pole portion forming portion 82, the first magnetic pole portion forming portion 81, the second magnetic pole portion forming portion 82, the second magnetic pole portion forming portion 82, and the second magnetic pole portion forming portion 82 in a clockwise direction in FIG. 6A when viewed in the axial direction. The rotor 10 for the rotary electric machine is formed by laminating the electromagnetic steel sheets 40A in the axial direction while rotating the electromagnetic steel sheets 40A one by one in the circumferential direction by 45 degrees.

Therefore, the inner wall portion 511 of the first magnet accommodating hole 51 of the rotor 10 for the rotary electric machine is formed by laminating the first protrusion forming surface 7111, the first void forming surface 7211, the first void forming surface 7211, the first void forming surface 7211, the first protrusion forming surface 7111, the first void forming surface 7211, the first void forming surface 7211, and the first void forming surface 7211 in this order. Accordingly, the first protrusion 510a is formed by the first protrusion forming surface 7111, and the first void 510b is formed by the first void forming surface 7211. In this way, the first low saturation magnetic flux density portion 510 is formed in the inner wall portion 511 of the first magnet accommodating hole 51.

At this time, the magnet insertion holes 70 forming the first magnet accommodating holes 51 formed in the electromagnetic steel sheets 40A are arranged along the circumferential direction, each in a pattern of the protrusion forming magnet insertion hole 71, the void forming magnet insertion hole 72, the void forming magnet insertion hole 72, the void forming magnet insertion hole 72, the protrusion forming magnet insertion hole 71, the void forming magnet insertion hole 72, the void forming magnet insertion hole 72, and the void forming magnet insertion hole 72.

The inner wall portion 521 of the second magnet accommodating hole 52 of the rotor 10 for the rotary electric machine is formed by laminating the second protrusion forming surface 7121, the second void forming surface 7221, the second void forming surface 7221, the second void forming surface 7221, the second protrusion forming surface 7121, the second void forming surface 7221, the second void forming surface 7221, and the second void forming surface 7221 in this order. Accordingly, the second protrusion 520a is formed by the second protrusion forming surface 7121, and the second void 520b is formed by the second void forming surface 7221. In this way, the second low saturation magnetic flux density portion 520 is formed in the inner wall portion 521 of the second magnet accommodating hole 52.

At this time, the magnet insertion holes 70 forming the second magnet accommodating holes 52 formed in the electromagnetic steel sheets 40A are arranged along the circumferential direction, each in a pattern of the protrusion forming magnet insertion hole 71, the void forming magnet insertion hole 72, the void forming magnet insertion hole 72, the void forming magnet insertion hole 72, the protrusion forming magnet insertion hole 71, the void forming magnet insertion hole 72, the void forming magnet insertion hole 72, and the void forming magnet insertion hole 72.

The inner wall portion 531 of the third magnet accommodating hole 53 of the rotor 10 for the rotary electric machine is formed by laminating the third protrusion forming surface 7131, the third void forming surface 7231, the third void forming surface 7231, the third void forming surface 7231, the third protrusion forming surface 7131, the third void forming surface 7231, the third void forming surface 7231, and the third void forming surface 7231 in this order. Accordingly, the third protrusion 530a is formed by the third protrusion forming surface 7131, and the third void 530b is formed by the third void forming surface 7231. In this way, the third low saturation magnetic flux density portion 530 is formed in the inner wall portion 531 of the third magnet accommodating hole 53.

At this time, the magnet insertion holes 70 forming the third magnet accommodating holes 53 formed in the electromagnetic steel sheets 40A are arranged along the circumferential direction, each in a pattern of the protrusion forming magnet insertion hole 71, the void forming magnet insertion hole 72, the void forming magnet insertion hole 72, the void forming magnet insertion hole 72, the protrusion forming magnet insertion hole 71, the void forming magnet insertion hole 72, the void forming magnet insertion hole 72, and the void forming magnet insertion hole 72.

As described above, the magnet insertion hole 70 forming the first magnet accommodating hole 51, the magnet insertion hole 70 forming the second magnet accommodating hole 52, and the magnet insertion hole 70 forming the third magnet accommodating hole 53 formed in the electromagnetic steel sheets 40A are configured such that the protrusion forming magnet insertion holes 71 and the void forming magnet insertion holes 72 are arranged in a predetermined pattern along the circumferential direction. The first low saturation magnetic flux density portion 510, the second low saturation magnetic flux density portion 520, and the third low saturation magnetic flux density portion 530 are formed by overlapping in the axial direction the protrusion forming magnet insertion holes 71 and the void forming magnet insertion holes 72 by laminating the plurality of electromagnetic steel sheets 40A while rotating the electromagnetic steel sheets 40A one by one in the circumferential direction by 45 degrees.

Accordingly, the first low saturation magnetic flux density portion 510, the second low saturation magnetic flux density portion 520, and the third low saturation magnetic flux density portion 530 can be formed of a single type of electromagnetic steel sheet 40A, and thus the first low saturation magnetic flux density portion 510, the second low saturation magnetic flux density portion 520, and the third low saturation magnetic flux density portion 530 can be formed easily at low cost.

### Second Example

As illustrated in FIG. 6B, the electromagnetic steel sheet 40B according to the second example of the present embodiment includes a plurality of magnetic pole portion forming portions 80 formed along a circumferential direction. The plurality of magnetic pole portion forming portions 80 are formed at equal intervals along the circumferential direction. In the present embodiment, eight magnetic pole portion forming portions 80 are formed at equal intervals along the circumferential direction, that is, at intervals of 45 degrees.

The magnetic pole portion forming portion 80 of the electromagnetic steel sheet 40B includes the first magnetic pole portion forming portion 81 and the second magnetic pole portion forming portion 82.

The first magnetic pole portion forming portion 81 is provided with the first protrusion forming magnet insertion hole 711 overlapping in an axial direction to form the first magnet accommodating hole 51, the second protrusion forming magnet insertion hole 712 overlapping in the axial direction to form the second magnet accommodating hole 52, and the third protrusion forming magnet insertion hole 713 overlapping in the axial direction to form the third magnet accommodating hole 53. A distance between the inner surface 611 of the first permanent magnet 61 and the inner wall portion 511 of the first magnet accommodating hole 51 is the first distance D11 in the first protrusion forming magnet insertion hole 711, a distance between the inner surface 621 of the second permanent magnet 62 and the inner wall portion 521 of the second magnet accommodating hole 52 is the first distance D21 in the second protrusion forming magnet insertion hole 712, and a distance between the inner surface 631 of the third permanent magnet 63 and the inner wall portion 531 of the third magnet accommodating hole 53 is the first distance D31 in the third protrusion forming magnet insertion hole 713.

The second magnetic pole portion forming portion 82 is provided with the first void forming magnet insertion hole 721 overlapping in the axial direction to form the first magnet accommodating hole 51, the second void forming magnet insertion hole 722 overlapping in the axial direction to form the second magnet accommodating hole 52, and the third void forming magnet insertion hole 723 overlapping in the axial direction to form the third magnet accommodating hole 53. A distance between the inner surface 611 of the first permanent magnet 61 and the inner wall portion 511 of the first magnet accommodating hole 51 is the second distance D12 in the first void forming magnet insertion hole 721, a distance between the inner surface 621 of the second permanent magnet 62 and the inner wall portion 521 of the second magnet accommodating hole 52 is the second distance D22 in the second void forming magnet insertion hole 722, and a distance between the inner surface 631 of the third permanent magnet 63 and the inner wall portion 531 of the third magnet accommodating hole 53 is the second distance D32 in the third void forming magnet insertion hole 723.

In the electromagnetic steel sheet 40B according to the second example of the present embodiment, eight magnetic pole portion forming portions 80 are formed at equal intervals along the circumferential direction in an order of the first magnetic pole portion forming portion 81, the second magnetic pole portion forming portion 82, the second magnetic pole portion forming portion 82, the first magnetic pole portion forming portion 81, the second magnetic pole portion forming portion 82, the first magnetic pole portion forming portion 81, the second magnetic pole portion forming portion 82, and the second magnetic pole portion forming portion 82 in a clockwise direction in FIG. 6B when viewed in the axial direction. The rotor 10 for the rotary electric machine is formed by laminating the electromagnetic steel sheets 40B in the axial direction while rotating the electromagnetic steel sheets 40B one by one in the circumferential direction by 45 degrees.

Therefore, the inner wall portion 511 of the first magnet accommodating hole 51 of the rotor 10 for the rotary electric machine is formed by laminating the first protrusion forming surface 7111, the first void forming surface 7211, the first void forming surface 7211, the first protrusion forming surface 7111, the first void forming surface 7211, the first protrusion forming surface 7111, the first void forming surface 7211, and the first void forming surface 7211 in this order. Accordingly, the first protrusion 510a is formed by the first protrusion forming surface 7111, and the first void 510b is formed by the first void forming surface 7211. In this way, the first low saturation magnetic flux density portion 510 is formed in the inner wall portion 511 of the first magnet accommodating hole 51.

At this time, the magnet insertion holes 70 forming the first magnet accommodating holes 51 formed in the electromagnetic steel sheets 40B are arranged along the circumferential direction, each in a pattern of the protrusion forming magnet insertion hole 71, the void forming magnet insertion hole 72, the void forming magnet insertion hole 72, the protrusion forming magnet insertion hole 71, the void forming magnet insertion hole 72, the protrusion forming magnet insertion hole 71, the void forming magnet insertion hole 72, and the void forming magnet insertion hole 72.

The inner wall portion 521 of the second magnet accommodating hole 52 of the rotor 10 for the rotary electric machine is formed by laminating the second protrusion forming surface 7121, the second void forming surface 7221, the second void forming surface 7221, the second protrusion forming surface 7121, the second void forming surface 7221, the second protrusion forming surface 7121, the second void forming surface 7221, and the second void forming surface 7221 in this order. Accordingly, the second protrusion 520a is formed by the second protrusion forming surface 7121, and the second void 520b is formed by the second void forming surface 7221. In this way, the second low saturation magnetic flux density portion 520 is formed in the inner wall portion 521 of the second magnet accommodating hole 52.

At this time, the magnet insertion holes 70 forming the second magnet accommodating holes 52 formed in the electromagnetic steel sheets 40B are arranged along the circumferential direction, each in a pattern of the protrusion forming magnet insertion hole 71, the void forming magnet insertion hole 72, the void forming magnet insertion hole 72, the protrusion forming magnet insertion hole 71, the void forming magnet insertion hole 72, the protrusion forming magnet insertion hole 71, the void forming magnet insertion hole 72, and the void forming magnet insertion hole 72.

The inner wall portion 531 of the third magnet accommodating hole 53 of the rotor 10 for the rotary electric machine is formed by laminating the third protrusion forming surface 7131, the third void forming surface 7231, the third void forming surface 7231, the third protrusion forming surface 7131, the third void forming surface 7231, the third protrusion forming surface 7131, the third void forming surface 7231, and the third void forming surface 7231 in this order. Accordingly, the third protrusion 530a is formed by the third protrusion forming surface 7131, and the third void 530b is formed by the third void forming surface 7231. In this way, the third low saturation magnetic flux density portion 530 is formed in the inner wall portion 531 of the third magnet accommodating hole 53.

At this time, the magnet insertion holes 70 forming the third magnet accommodating holes 53 formed in the electromagnetic steel sheets 40B are arranged along the circumferential direction, each in a pattern of the protrusion forming magnet insertion hole 71, the void forming magnet insertion hole 72, the void forming magnet insertion hole 72, the protrusion forming magnet insertion hole 71, the void forming magnet insertion hole 72, the protrusion forming magnet insertion hole 71, the void forming magnet insertion hole 72, and the void forming magnet insertion hole 72.

As described above, the magnet insertion hole 70 forming the first magnet accommodating hole 51, the magnet insertion hole 70 forming the second magnet accommodating hole 52, and the magnet insertion hole 70 forming the third magnet accommodating hole 53 formed in the electromagnetic steel sheets 40B are configured such that the protrusion forming magnet insertion holes 71 and the void forming magnet insertion holes 72 are arranged in a predetermined pattern along the circumferential direction. The first low saturation magnetic flux density portion 510, the second low saturation magnetic flux density portion 520, and the third low saturation magnetic flux density portion 530 are formed by overlapping in the axial direction the protrusion forming magnet insertion holes 71 and the void forming magnet insertion holes 72 by laminating the plurality of electromagnetic steel sheets 40B while rotating the electromagnetic steel sheets 40B one by one in the circumferential direction by 45 degrees.

Accordingly, the first low saturation magnetic flux density portion 510, the second low saturation magnetic flux density portion 520, and the third low saturation magnetic flux density portion 530 can be formed of a single type of electromagnetic steel sheet 40B, and thus the first low saturation magnetic flux density portion 510, the second low saturation magnetic flux density portion 520, and the third low saturation magnetic flux density portion 530 can be formed easily at low cost.

### Third Example

As illustrated in FIG. 6C, the electromagnetic steel sheet 40C according to the third example of the present embodiment includes a plurality of magnetic pole portion forming portions 80 formed along a circumferential direction. The plurality of magnetic pole portion forming portions 80 are formed at equal intervals along the circumferential direction. In the present embodiment, eight magnetic pole portion forming portions 80 are formed at equal intervals along the circumferential direction, that is, at intervals of 45 degrees.

The magnetic pole portion forming portion 80 of the electromagnetic steel sheet 40C includes the first magnetic pole portion forming portion 81 and the second magnetic pole portion forming portion 82.

The first magnetic pole portion forming portion 81 is provided with the first protrusion forming magnet insertion hole 711 overlapping in an axial direction to form the first magnet accommodating hole 51, the second protrusion forming magnet insertion hole 712 overlapping in the axial direction to form the second magnet accommodating hole 52, and the third protrusion forming magnet insertion hole 713 overlapping in the axial direction to form the third magnet accommodating hole 53. A distance between the inner surface 611 of the first permanent magnet 61 and the inner wall portion 511 of the first magnet accommodating hole 51 is the first distance D11 in the first protrusion forming magnet insertion hole 711, a distance between the inner surface 621 of the second permanent magnet 62 and the inner wall portion 521 of the second magnet accommodating hole 52 is the first distance D21 in the second protrusion forming magnet insertion hole 712, and a distance between the inner surface 631 of the third permanent magnet 63 and the inner wall portion 531 of the third magnet accommodating hole 53 is the first distance D31 in the third protrusion forming magnet insertion hole 713.

The second magnetic pole portion forming portion 82 is provided with the first void forming magnet insertion hole 721 overlapping in the axial direction to form the first magnet accommodating hole 51, the second void forming magnet insertion hole 722 overlapping in the axial direction to form the second magnet accommodating hole 52, and the third void forming magnet insertion hole 723 overlapping in the axial direction to form the third magnet accommodating hole 53. A distance between the inner surface 611 of the first permanent magnet 61 and the inner wall portion 511 of the first magnet accommodating hole 51 is the second distance D12 in the first void forming magnet insertion hole 721, a distance between the inner surface 621 of the second permanent magnet 62 and the inner wall portion 521 of the second magnet accommodating hole 52 is the second distance D22 in the second void forming magnet insertion hole 722, and a distance between the inner surface 631 of the third permanent magnet 63 and the inner wall portion 531 of the third magnet accommodating hole 53 is the second distance D32 in the third void forming magnet insertion hole 723.

In the electromagnetic steel sheet 40C according to the third example of the present embodiment, eight magnetic pole portion forming portions 80 are formed at equal intervals along the circumferential direction in an order of the first magnetic pole portion forming portion 81, the second magnetic pole portion forming portion 82, the first magnetic pole portion forming portion 81, the second magnetic pole portion forming portion 82, the first magnetic pole portion forming portion 81, the second magnetic pole portion forming portion 82, the first magnetic pole portion forming portion 81, and the second magnetic pole portion forming portion 82 in a clockwise direction in FIG. 6C when viewed in the axial direction. The rotor 10 for the rotary electric machine is formed by laminating the electromagnetic steel sheets 40C in the axial direction while rotating the electromagnetic steel sheets 40C one by one in the circumferential direction by 45 degrees.

Therefore, the inner wall portion 511 of the first magnet accommodating hole 51 of the rotor 10 for the rotary electric machine is formed by laminating the first protrusion forming surface 7111, the first void forming surface 7211, the first protrusion forming surface 7111, the first void forming surface 7211, the first protrusion forming surface 7111, the first void forming surface 7211, the first protrusion forming surface 7111, and the first void forming surface 7211 in this order. Accordingly, the first protrusion 510a is formed by the first protrusion forming surface 7111, and the first void 510b is formed by the first void forming surface 7211. In this way, the first low saturation magnetic flux density portion 510 is formed in the inner wall portion 511 of the first magnet accommodating hole 51.

At this time, the magnet insertion holes 70 forming the first magnet accommodating holes 51 formed in the electromagnetic steel sheets 40C are arranged along the circumferential direction, each in a pattern of the protrusion forming magnet insertion hole 71, the void forming magnet insertion hole 72, the protrusion forming magnet insertion hole 71, the void forming magnet insertion hole 72, the protrusion forming magnet insertion hole 71, the void forming magnet insertion hole 72, the protrusion forming magnet insertion hole 71, and the void forming magnet insertion hole 72.

The inner wall portion 521 of the second magnet accommodating hole 52 of the rotor 10 for the rotary electric machine is formed by laminating the second protrusion forming surface 7121, the second void forming surface 7221, the second protrusion forming surface 7121, the second void forming surface 7221, the second protrusion forming surface 7121, the second void forming surface 7221, the second protrusion forming surface 7121, and the second void forming surface 7221 in this order. Accordingly, the second protrusion 520a is formed by the second protrusion forming surface 7121, and the second void 520b is formed by the second void forming surface 7221. In this way, the second low saturation magnetic flux density portion 520 is formed in the inner wall portion 521 of the second magnet accommodating hole 52.

At this time, the magnet insertion holes 70 forming the second magnet accommodating holes 52 formed in the electromagnetic steel sheets 40C are arranged along the circumferential direction, each in a pattern of the protrusion forming magnet insertion hole 71, the void forming magnet insertion hole 72, the protrusion forming magnet insertion hole 71, the void forming magnet insertion hole 72, the protrusion forming magnet insertion hole 71, the void forming magnet insertion hole 72, the protrusion forming magnet insertion hole 71, and the void forming magnet insertion hole 72.

The inner wall portion 531 of the third magnet accommodating hole 53 of the rotor 10 for the rotary electric machine is formed by laminating the third protrusion forming surface 7131, the third void forming surface 7231, the third protrusion forming surface 7131, the third void forming surface 7231, the third protrusion forming surface 7131, the third void forming surface 7231, the third protrusion forming surface 7131, and the third void forming surface 7231 in this order. Accordingly, the third protrusion 530a is formed by the third protrusion forming surface 7131, and the third void 530b is formed by the third void forming surface 7231. In this way, the third low saturation magnetic flux density portion 530 is formed in the inner wall portion 531 of the third magnet accommodating hole 53.

At this time, the magnet insertion holes 70 forming the third magnet accommodating holes 53 formed in the electromagnetic steel sheets 40C are arranged along the circumferential direction, each in a pattern of the protrusion forming magnet insertion hole 71, the void forming magnet insertion hole 72, the protrusion forming magnet insertion hole 71, the void forming magnet insertion hole 72, the protrusion forming magnet insertion hole 71, the void forming magnet insertion hole 72, the protrusion forming magnet insertion hole 71, and the void forming magnet insertion hole 72.

As described above, the magnet insertion hole 70 forming the first magnet accommodating hole 51, the magnet insertion hole 70 forming the second magnet accommodating hole 52, and the magnet insertion hole 70 forming the third magnet accommodating hole 53 formed in the electromagnetic steel sheets 40C are configured such that the protrusion forming magnet insertion holes 71 and the void forming magnet insertion holes 72 are arranged in a predetermined pattern along the circumferential direction. The first low saturation magnetic flux density portion 510, the second low saturation magnetic flux density portion 520, and the third low saturation magnetic flux density portion 530 are formed by overlapping in the axial direction the protrusion forming magnet insertion holes 71 and the void forming magnet insertion holes 72 by laminating the plurality of electromagnetic steel sheets 40C while rotating the electromagnetic steel sheets 40C one by one in the circumferential direction by 45 degrees.

Accordingly, the first low saturation magnetic flux density portion 510, the second low saturation magnetic flux density portion 520, and the third low saturation magnetic flux density portion 530 can be formed of a single type of electromagnetic steel sheet 40C, and thus the first low saturation magnetic flux density portion 510, the second low saturation magnetic flux density portion 520, and the third low saturation magnetic flux density portion 530 can be formed easily at low cost.

### Fourth Example

As illustrated in FIG. 6D, the electromagnetic steel sheet 40D according to the fourth example of the present embodiment includes a plurality of magnetic pole portion forming portions 80 formed along a circumferential direction. The plurality of magnetic pole portion forming portions 80 are formed at equal intervals along the circumferential direction. In the present embodiment, eight magnetic pole portion forming portions 80 are formed at equal intervals along the circumferential direction, that is, at intervals of 45 degrees.

The magnetic pole portion forming portion 80 of the electromagnetic steel sheet 40D includes the first magnetic pole portion forming portion 81 and the second magnetic pole portion forming portion 82.

The first magnetic pole portion forming portion 81 is provided with the first protrusion forming magnet insertion hole 711 overlapping in an axial direction to form the first magnet accommodating hole 51, the second protrusion forming magnet insertion hole 712 overlapping in the axial direction to form the second magnet accommodating hole 52, and the third protrusion forming magnet insertion hole 713 overlapping in the axial direction to form the third magnet accommodating hole 53. A distance between the inner surface 611 of the first permanent magnet 61 and the inner wall portion 511 of the first magnet accommodating hole 51 is the first distance D11 in the first protrusion forming magnet insertion hole 711, a distance between the inner surface 621 of the second permanent magnet 62 and the inner wall portion 521 of the second magnet accommodating hole 52 is the first distance D21 in the second protrusion forming magnet insertion hole 712, and a distance between the inner surface 631 of the third permanent magnet 63 and the inner wall portion 531 of the third magnet accommodating hole 53 is the first distance D31 in the third protrusion forming magnet insertion hole 713.

The second magnetic pole portion forming portion 82 is provided with the first void forming magnet insertion hole 721 overlapping in the axial direction to form the first magnet accommodating hole 51, the second void forming magnet insertion hole 722 overlapping in the axial direction to form the second magnet accommodating hole 52, and the third void forming magnet insertion hole 723 overlapping in the axial direction to form the third magnet accommodating hole 53. A distance between the inner surface 611 of the first permanent magnet 61 and the inner wall portion 511 of the first magnet accommodating hole 51 is the second distance D12 in the first void forming magnet insertion hole 721, a distance between the inner surface 621 of the second permanent magnet 62 and the inner wall portion 521 of the second magnet accommodating hole 52 is the second distance D22 in the second void forming magnet insertion hole 722, and a distance between the inner surface 631 of the third permanent magnet 63 and the inner wall portion 531 of the third magnet accommodating hole 53 is the second distance D32 in the third void forming magnet insertion hole 723.

In the electromagnetic steel sheet 40D according to the fourth example of the present embodiment, eight magnetic pole portion forming portions 80 are formed at equal intervals along the circumferential direction in an order of the first magnetic pole portion forming portion 81, the second magnetic pole portion forming portion 82, the first magnetic pole portion forming portion 81, the first magnetic pole portion forming portion 81, the second magnetic pole portion forming portion 82, the first magnetic pole portion forming portion 81, the first magnetic pole portion forming portion 81, and the second magnetic pole portion forming portion 82 in a clockwise direction in FIG. 6D when viewed in the axial direction. The rotor 10 for the rotary electric machine is formed by laminating the electromagnetic steel sheets 40D in the axial direction while rotating the electromagnetic steel sheets 40D one by one in the circumferential direction by 45 degrees.

Therefore, the inner wall portion 511 of the first magnet accommodating hole 51 of the rotor 10 for the rotary electric machine is formed by laminating the first protrusion forming surface 7111, the first void forming surface 7211, the first protrusion forming surface 7111, the first protrusion forming surface 7111, the first void forming surface 7211, the first protrusion forming surface 7111, the first protrusion forming surface 7111, and the first void forming surface 7211 in this order. Accordingly, the first protrusion 510a is formed by the first protrusion forming surface 7111, and the first void 510b is formed by the first void forming surface 7211. In this way, the first low saturation magnetic flux density portion 510 is formed in the inner wall portion 511 of the first magnet accommodating hole 51.

At this time, the magnet insertion holes 70 forming the first magnet accommodating holes 51 formed in the electromagnetic steel sheets 40D are arranged along the circumferential direction, each in a pattern of the protrusion forming magnet insertion hole 71, the void forming magnet insertion hole 72, the protrusion forming magnet insertion hole 71, the protrusion forming magnet insertion hole 71, the void forming magnet insertion hole 72, the protrusion forming magnet insertion hole 71, the protrusion forming magnet insertion hole 71, and the void forming magnet insertion hole 72.

The inner wall portion 521 of the second magnet accommodating hole 52 of the rotor 10 for the rotary electric machine is formed by laminating the second protrusion forming surface 7121, the second void forming surface 7221, the second protrusion forming surface 7121, the second protrusion forming surface 7121, the second void forming surface 7221, the second protrusion forming surface 7121, the second protrusion forming surface 7121, and the second void forming surface 7221 in this order. Accordingly, the second protrusion 520a is formed by the second protrusion forming surface 7121, and the second void 520b is formed by the second void forming surface 7221. In this way, the second low saturation magnetic flux density portion 520 is formed in the inner wall portion 521 of the second magnet accommodating hole 52.

At this time, the magnet insertion holes 70 forming the second magnet accommodating holes 52 formed in the electromagnetic steel sheets 40D are arranged along the circumferential direction, each in a pattern of the protrusion forming magnet insertion hole 71, the void forming magnet insertion hole 72, the protrusion forming magnet insertion hole 71, the protrusion forming magnet insertion hole 71, the void forming magnet insertion hole 72, the protrusion forming magnet insertion hole 71, the protrusion forming magnet insertion hole 71, and the void forming magnet insertion hole 72.

The inner wall portion 531 of the third magnet accommodating hole 53 of the rotor 10 for the rotary electric machine is formed by laminating the third protrusion forming surface 7131, the third void forming surface 7231, the third protrusion forming surface 7131, the third protrusion forming surface 7131, the third void forming surface 7231, the third protrusion forming surface 7131, the third protrusion forming surface 7131, and the third void forming surface 7231 in this order. Accordingly, the third protrusion 530a is formed by the third protrusion forming surface 7131, and the third void 530b is formed by the third void forming surface 7231. In this way, the third low saturation magnetic flux density portion 530 is formed in the inner wall portion 531 of the third magnet accommodating hole 53.

At this time, the magnet insertion holes 70 forming the third magnet accommodating holes 53 formed in the electromagnetic steel sheets 40D are arranged along the circumferential direction, each in a pattern of the protrusion forming magnet insertion hole 71, the void forming magnet insertion hole 72, the protrusion forming magnet insertion hole 71, the protrusion forming magnet insertion hole 71, the void forming magnet insertion hole 72, the protrusion forming magnet insertion hole 71, the protrusion forming magnet insertion hole 71, and the void forming magnet insertion hole 72.

As described above, the magnet insertion hole 70 forming the first magnet accommodating hole 51, the magnet insertion hole 70 forming the second magnet accommodating hole 52, and the magnet insertion hole 70 forming the third magnet accommodating hole 53 formed in the electromagnetic steel sheets 40D are configured such that the protrusion forming magnet insertion holes 71 and the void forming magnet insertion holes 72 are arranged in a predetermined pattern along the circumferential direction. The first low saturation magnetic flux density portion 510, the second low saturation magnetic flux density portion 520, and the third low saturation magnetic flux density portion 530 are formed by overlapping in the axial direction the protrusion forming magnet insertion holes 71 and the void forming magnet insertion holes 72 by laminating the plurality of electromagnetic steel sheets 40D while rotating the electromagnetic steel sheets 40D one by one in the circumferential direction by 45 degrees.

Accordingly, the first low saturation magnetic flux density portion 510, the second low saturation magnetic flux density portion 520, and the third low saturation magnetic flux density portion 530 can be formed of a single type of electromagnetic steel sheet 40D, and thus the first low saturation magnetic flux density portion 510, the second low saturation magnetic flux density portion 520, and the third low saturation magnetic flux density portion 530 can be formed easily at low cost.

### Fifth Example

As illustrated in FIG. 6E, the electromagnetic steel sheet 40E according to the fifth example of the present embodiment includes a plurality of magnetic pole portion forming portions 80 formed along a circumferential direction. The plurality of magnetic pole portion forming portions 80 are formed at equal intervals along the circumferential direction. In the present embodiment, eight magnetic pole portion forming portions 80 are formed at equal intervals along the circumferential direction, that is, at intervals of 45 degrees.

The magnetic pole portion forming portion 80 of the electromagnetic steel sheet 40D includes the first magnetic pole portion forming portion 81, the second magnetic pole portion forming portion 82, and a third magnetic pole portion forming portion 83.

The first magnetic pole portion forming portion 81 is provided with the first protrusion forming magnet insertion hole 711 overlapping in an axial direction to form the first magnet accommodating hole 51, the second protrusion forming magnet insertion hole 712 overlapping in the axial direction to form the second magnet accommodating hole 52, and the third protrusion forming magnet insertion hole 713 overlapping in the axial direction to form the third magnet accommodating hole 53. A distance between the inner surface 611 of the first permanent magnet 61 and the inner wall portion 511 of the first magnet accommodating hole 51 is the first distance D11 in the first protrusion forming magnet insertion hole 711, a distance between the inner surface 621 of the second permanent magnet 62 and the inner wall portion 521 of the second magnet accommodating hole 52 is the first distance D21 in the second protrusion forming magnet insertion hole 712, and a distance between the inner surface 631 of the third permanent magnet 63 and the inner wall portion 531 of the third magnet accommodating hole 53 is the first distance D31 in the third protrusion forming magnet insertion hole 713.

The second magnetic pole portion forming portion 82 is provided with the first void forming magnet insertion hole 721 overlapping in the axial direction to form the first magnet accommodating hole 51, the second void forming magnet insertion hole 722 overlapping in the axial direction to form the second magnet accommodating hole 52, and the third void forming magnet insertion hole 723 overlapping in the axial direction to form the third magnet accommodating hole 53. A distance between the inner surface 611 of the first permanent magnet 61 and the inner wall portion 511 of the first magnet accommodating hole 51 is the second distance D12 in the first void forming magnet insertion hole 721, a distance between the inner surface 621 of the second permanent magnet 62 and the inner wall portion 521 of the second magnet accommodating hole 52 is the second distance D22 in the second void forming magnet insertion hole 722, and a distance between the inner surface 631 of the third permanent magnet 63 and the inner wall portion 531 of the third magnet accommodating hole 53 is the second distance D32 in the third void forming magnet insertion hole 723.

The third magnetic pole portion forming portion 83 is provided with the first void forming magnet insertion hole 721 overlapping in the axial direction to form the first magnet accommodating hole 51, the second protrusion forming magnet insertion hole 712 overlapping in the axial direction to form the second magnet accommodating hole 52, and the third protrusion forming magnet insertion hole 713 overlapping in the axial direction to form the third magnet accommodating hole 53. A distance between the inner surface 611 of the first permanent magnet 61 and the inner wall portion 511 of the first magnet accommodating hole 51 is the second distance D12 in the first void forming magnet insertion hole 721, a distance between the inner surface 621 of the second permanent magnet 62 and the inner wall portion 521 of the second magnet accommodating hole 52 is the first distance D21 in the second protrusion forming magnet insertion hole 712, and a distance between the inner surface 631 of the third permanent magnet 63 and the inner wall portion 531 of the third magnet accommodating hole 53 is the first distance D31 in the third protrusion forming magnet insertion hole 713.

In the electromagnetic steel sheet 40E according to the fifth example of the present embodiment, eight magnetic pole portion forming portions 80 are formed at equal intervals along the circumferential direction in an order of the first magnetic pole portion forming portion 81, the second magnetic pole portion forming portion 82, the third magnetic pole portion forming portion 83, the second magnetic pole portion forming portion 82, the first magnetic pole portion forming portion 81, the second magnetic pole portion forming portion 82, the third magnetic pole portion forming portion 83, and the second magnetic pole portion forming portion 82 in a clockwise direction in FIG. 6E when viewed in the axial direction. The rotor 10 for the rotary electric machine is formed by laminating the electromagnetic steel sheets 40E in the axial direction while rotating the electromagnetic steel sheets 40E one by one in the circumferential direction by 45 degrees.

Therefore, the inner wall portion 511 of the first magnet accommodating hole 51 of the rotor 10 for the rotary electric machine is formed by laminating the first protrusion forming surface 7111, the first void forming surface 7211, the first void forming surface 7211, the first void forming surface 7211, the first protrusion forming surface 7111, the first void forming surface 7211, the first void forming surface 7211, and the first void forming surface 7211 in this order. Accordingly, the first protrusion 510a is formed by the first protrusion forming surface 7111, and the first void 510b is formed by the first void forming surface 7211. In this way, the first low saturation magnetic flux density portion 510 is formed in the inner wall portion 511 of the first magnet accommodating hole 51.

At this time, the magnet insertion holes 70 forming the first magnet accommodating holes 51 formed in the electromagnetic steel sheets 40D are arranged along the circumferential direction, each in a pattern of the protrusion forming magnet insertion hole 71, the void forming magnet insertion hole 72, the void forming magnet insertion hole 72, the void forming magnet insertion hole 72, the protrusion forming magnet insertion hole 71, the void forming magnet insertion hole 72, the void forming magnet insertion hole 72, and the void forming magnet insertion hole 72.

The inner wall portion 521 of the second magnet accommodating hole 52 of the rotor 10 for the rotary electric machine is formed by laminating the second protrusion forming surface 7121, the second void forming surface 7221, the second protrusion forming surface 7121, the second void forming surface 7221, the second protrusion forming surface 7121, the second void forming surface 7221, the second protrusion forming surface 7121, and the second void forming surface 7221 in this order. Accordingly, the second protrusion 520a is formed by the second protrusion forming surface 7121, and the second void 520b is formed by the second void forming surface 7221. In this way, the second low saturation magnetic flux density portion 520 is formed in the inner wall portion 521 of the second magnet accommodating hole 52.

At this time, the magnet insertion holes 70 forming the second magnet accommodating holes 52 formed in the electromagnetic steel sheets 40E are arranged along the circumferential direction, each in a pattern of the protrusion forming magnet insertion hole 71, the void forming magnet insertion hole 72, the protrusion forming magnet insertion hole 71, the void forming magnet insertion hole 72, the protrusion forming magnet insertion hole 71, the void forming magnet insertion hole 72, the protrusion forming magnet insertion hole 71, and the void forming magnet insertion hole 72.

The inner wall portion 531 of the third magnet accommodating hole 53 of the rotor 10 for the rotary electric machine is formed by laminating the third protrusion forming surface 7131, the third void forming surface 7231, the third protrusion forming surface 7131, the third void forming surface 7231, the third protrusion forming surface 7131, the third void forming surface 7231, the third protrusion forming surface 7131, and the third void forming surface 7231 in this order. Accordingly, the third protrusion 530a is formed by the third protrusion forming surface 7131, and the third void 530b is formed by the third void forming surface 7231. In this way, the third low saturation magnetic flux density portion 530 is formed in the inner wall portion 531 of the third magnet accommodating hole 53.

At this time, the magnet insertion holes 70 forming the third magnet accommodating holes 53 formed in the electromagnetic steel sheets 40E are arranged along the circumferential direction, each in a pattern of the protrusion forming magnet insertion hole 71, the void forming magnet insertion hole 72, the protrusion forming magnet insertion hole 71, the void forming magnet insertion hole 72, the protrusion forming magnet insertion hole 71, the void forming magnet insertion hole 72, the protrusion forming magnet insertion hole 71, and the void forming magnet insertion hole 72.

As described above, the magnet insertion hole 70 forming the first magnet accommodating hole 51, the magnet insertion hole 70 forming the second magnet accommodating hole 52, and the magnet insertion hole 70 forming the third magnet accommodating hole 53 formed in the electromagnetic steel sheets 40E are configured such that the protrusion forming magnet insertion holes 71 and the void forming magnet insertion holes 72 are arranged in a predetermined pattern along the circumferential direction. The first low saturation magnetic flux density portion 510, the second low saturation magnetic flux density portion 520, and the third low saturation magnetic flux density portion 530 are formed by overlapping in the axial direction the protrusion forming magnet insertion holes 71 and the void forming magnet insertion holes 72 by laminating the plurality of electromagnetic steel sheets 40E while rotating the electromagnetic steel sheets 40E one by one in the circumferential direction by 45 degrees.

Accordingly, the first low saturation magnetic flux density portion 510, the second low saturation magnetic flux density portion 520, and the third low saturation magnetic flux density portion 530 can be formed of a single type of electromagnetic steel sheet 40E, and thus the first low saturation magnetic flux density portion 510, the second low saturation magnetic flux density portion 520, and the third low saturation magnetic flux density portion 530 can be formed easily at low cost.

The magnet insertion holes 70 forming the first magnet accommodating holes 51, the magnet insertion holes 70 forming the second magnet accommodating holes 52, and the magnet insertion holes 70 forming the third magnet accommodating holes 53 formed in the electromagnetic steel sheets 40E can be arranged such that the protrusion forming magnet insertion holes 71 and the void forming magnet insertion holes 72 have different patterns.

Accordingly, the first low saturation magnetic flux density portion 510, the second low saturation magnetic flux density portion 520, and the third low saturation magnetic flux density portion 530 can be formed such that the protrusion forming magnet insertion holes 71 and the void forming magnet insertion holes 72 are laminated in different patterns in the axial direction, so that a saturation magnetic flux density of the first low saturation magnetic flux density portion 510, a saturation magnetic flux density of the second low saturation magnetic flux density portion 520, and a saturation magnetic flux density of the third low saturation magnetic flux density portion 530 can be made different from each other.

### Third Embodiment

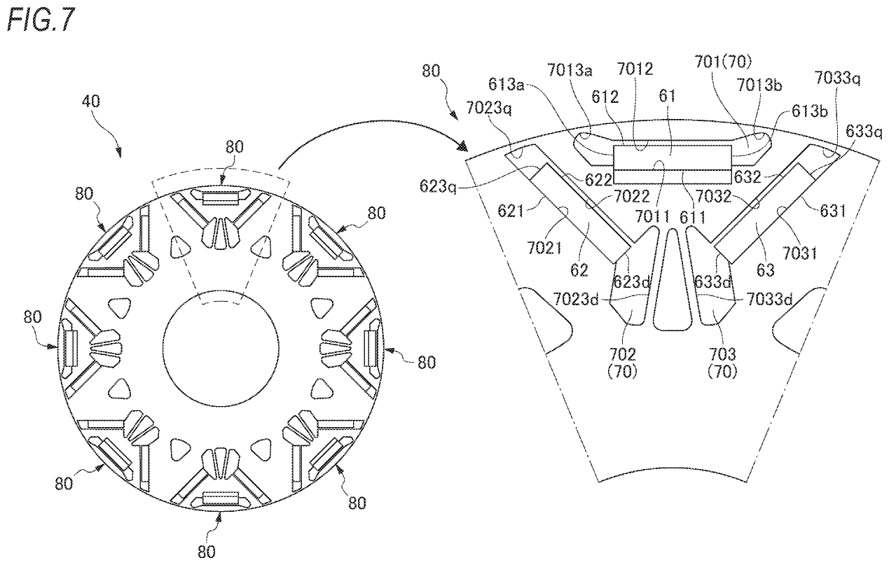

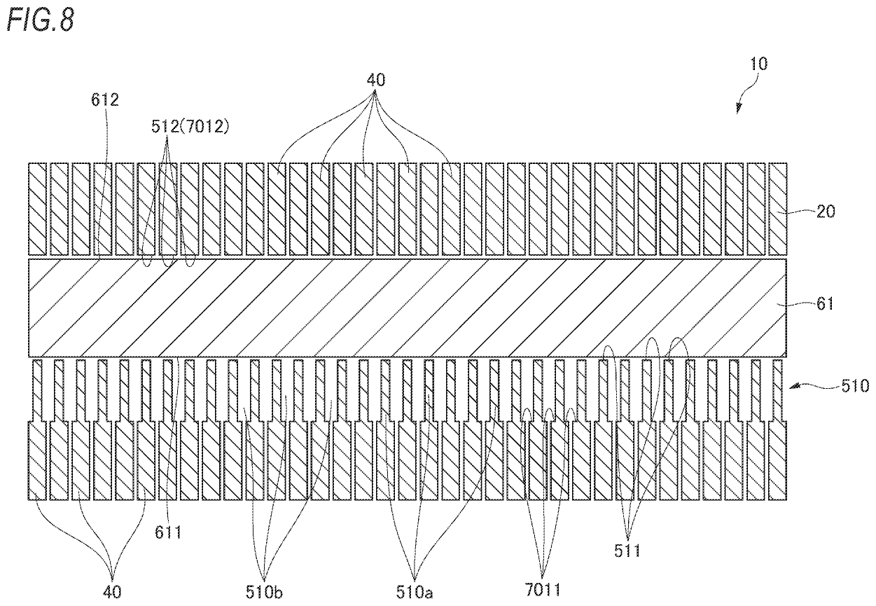

Next, the rotor 10 for a rotary electric machine according to a third embodiment of the present invention will be described with reference to FIGS. 7 and 8. In the following description, the same components as those of the rotor 10 for the rotary electric machine according to the first embodiment are denoted by the same reference numerals, and description thereof will be omitted or simplified. In the rotor 10 for the rotary electric machine according to the first embodiment, the electromagnetic steel sheet 40 includes the first electromagnetic steel sheet 41 in which the protrusion forming magnet insertion hole 71 is formed and the second electromagnetic steel sheet 42 in which the void forming magnet insertion hole 72 is formed, but in the rotor 10 for the rotary electric machine according to the third embodiment, the first protrusion 510a, the second protrusion 520a, and the third protrusion 530a of each electromagnetic steel sheet 40 are formed to be thinner than the electromagnetic steel sheet 40 in axial thickness by crushing or the like. Hereinafter, differences between the rotor 10 for the rotary electric machine according to the first embodiment and the rotor 10 for the rotary electric machine according to the third embodiment will be described in detail.

<Electromagnetic Steel Sheet>

As illustrated in FIG. 7, the magnet insertion holes 70 formed in each magnetic pole portion forming portion 80 of the electromagnetic steel sheet 40 include a first magnet insertion hole 701 overlapping in an axial direction to form the first magnet accommodating hole 51, a second magnet insertion hole 702 overlapping in the axial direction to form the second magnet accommodating hole 52, and a third magnet insertion hole 703 overlapping in the axial direction to form the third magnet accommodating hole 53. A plurality of the first magnet insertion holes 701, the second magnet insertion holes 702, and the third magnet insertion holes 703 are formed at equal intervals along a circumferential direction so as to correspond to the magnetic pole portions 30 of the rotor core 20. In the present embodiment, eight first magnet insertion holes 701, eight second magnet insertion holes 702, and eight third magnet insertion holes 703 are formed at equal intervals along the circumferential direction, that is, at intervals of 45 degrees.

The first magnet insertion hole 701 includes an inner wall portion forming surface 7011 facing the inner surface 611 of the first permanent magnet 61 and forming the inner wall portion 511 of the first magnet accommodating hole 51, an outer wall portion forming surface 7012 facing the outer surface 612 of the first permanent magnet 61 and forming the outer wall portion 512 of the first magnet accommodating hole 51, a first end wall portion forming surface 7013a connecting an end portion of the inner wall portion forming surface 7011 on one side in the circumferential direction and an end portion of the outer wall portion forming surface 7012 on one side in the circumferential direction to form the first end wall portion 513a of the first magnet accommodating hole 51, and a second end wall portion forming surface 7013b connecting an end portion of the inner wall portion forming surface 7011 on the other side in the circumferential direction and an end portion of the outer wall portion forming surface 7012 on the other side in the circumferential direction to form the second end wall portion 513b of the first magnet accommodating hole 51.

The second magnet insertion hole 702 includes an inner wall portion forming surface 7021 facing the inner surface 621 of the second permanent magnet 62 and forming the inner wall portion 521 of the second magnet accommodating hole 52, an outer wall portion forming surface 7022 facing the outer surface 622 of the second permanent magnet 62 and forming the outer wall portion 522 of the second magnet accommodating hole 52, a d-axis side wall portion forming surface 7023d connecting an end portion of the inner wall portion forming surface 7021 on a d-axis side and an end portion of the outer wall portion forming surface 7022 on the d-axis side to form the d-axis side wall portion 523d of the second magnet accommodating hole 52, and a q-axis side wall portion forming surface 7023q connecting an end portion of the inner wall portion forming surface 7021 on a q-axis side and an end portion of the outer wall portion forming surface 7022 on the q-axis side to form the q-axis side wall portion 523q of the second magnet accommodating hole 52.

The third magnet insertion hole 703 includes an inner wall portion forming surface 7031 facing the inner surface 631 of the third permanent magnet 63 and forming the inner wall portion 531 of the third magnet accommodating hole 53, an outer wall portion forming surface 7032 facing the outer surface 632 of the third permanent magnet 63 and forming the outer wall portion 532 of the third magnet accommodating hole 53, a d-axis side wall portion forming surface 7033d connecting an end portion of the inner wall portion forming surface 7031 on a d-axis side and an end portion of the outer wall portion forming surface 7032 on the d-axis side to form the d-axis side wall portion 533d of the third magnet accommodating hole 53, and a q-axis side wall portion forming surface 7033q connecting an end portion of the inner wall portion forming surface 7031 on a q-axis side and an end portion of the outer wall portion forming surface 7032 on the q-axis side to form the q-axis side wall portion 533q of the third magnet accommodating hole 53.

The first protrusion 510a protruding toward the first permanent magnet 61 is formed on the inner wall portion forming surface 7011 of the first magnet insertion hole 701. The first protrusion 510a is formed by crushing the electromagnetic steel sheet 40 or the like. The first protrusion 510a is formed integrally with the electromagnetic steel sheet 40 and has an axial thickness thinner than that of the electromagnetic steel sheet 40.

The second protrusion 520a protruding toward the second permanent magnet 62 is formed on the inner wall portion forming surface 7021 of the second magnet insertion hole 702. The second protrusion 520a is formed by crushing the electromagnetic steel sheet 40 or the like. The second protrusion 520a is formed integrally with the electromagnetic steel sheet 40 and has an axial thickness thinner than that of the electromagnetic steel sheet 40.

The third protrusion 530a protruding toward the third permanent magnet 63 is formed on the inner wall portion forming surface 7031 of the third magnet insertion hole 703. The third protrusion 530a is formed by crushing the electromagnetic steel sheet 40 or the like. The third protrusion 530a is formed integrally with the electromagnetic steel sheet 40 and has an axial thickness thinner than that of the electromagnetic steel sheet 40.

As illustrated in FIG. 8, when the electromagnetic steel sheets 40 are laminated in the axial direction, the axial thickness of the first protrusion 510a is thinner than that of the electromagnetic steel sheet 40, so that the inner wall portion 511 of the first magnet accommodating hole 51 is provided with the first low saturation magnetic flux density portion 510 having a plurality of first protrusions 510a formed along the axial direction and a plurality of first voids 510b formed between the adjacent first protrusions 510a and along the axial direction.

Similarly, although not illustrated in the drawings, when the electromagnetic steel sheets 40 are laminated in the axial direction, the axial thickness of the second protrusion 520a is thinner than that of the electromagnetic steel sheet 40, so that the inner wall portion 521 of the second magnet accommodating hole 52 is provided with the second low saturation magnetic flux density portion 520 having a plurality of second protrusions 520a formed along the axial direction and a plurality of second voids 520b formed between the adjacent second protrusions 520a and along the axial direction. Similarly, since the axial thickness of the third protrusion 530a is thinner than that of the electromagnetic steel sheet 40, the inner wall portion 531 of the third magnet accommodating hole 53 is provided with the third low saturation magnetic flux density portion 530 having a plurality of third protrusions 530a formed along the axial direction and a plurality of third voids 530b formed between the adjacent third protrusions 530a and along the axial direction.

Although the embodiments of the present invention have been described above with reference to the accompanying drawings, it is needless to say that the present invention is not limited to the embodiments. It will be apparent to those skilled in the art that various changes and modifications may be conceived within the scope of the claims, it is also understood that the various changes and modifications belong to the technical scope of the present invention. In addition, components in the embodiments described above may be combined as desired without departing from the spirit of the present invention.

For example, inside of the first magnet accommodating hole 51 including the first voids 510b of the first low saturation magnetic flux density portion 510, inside of the second magnet accommodating hole 52 including the second voids 520b of the second low saturation magnetic flux density portion 520, and inside of the third magnet accommodating hole 53 including the third voids 530b of the third low saturation magnetic flux density portion 530 may be filled with resin.

For example, in the present embodiment, the first low saturation magnetic flux density portion 510 is formed in the inner wall portion 511 of the first magnet accommodating hole 51, but the first low saturation magnetic flux density portion 510 may be formed in the outer wall portion 512 of the first magnet accommodating hole 51, or may be formed in both the inner wall portion 511 and the outer wall portion 512 of the first magnet accommodating hole 51.

For example, in the present embodiment, the second low saturation magnetic flux density portion 520 is formed in the inner wall portion 521 of the second magnet accommodating hole 52, but the second low saturation magnetic flux density portion 520 may be formed in the outer wall portion 522 of the second magnet accommodating hole 52, or may be formed in both the inner wall portion 521 and the outer wall portion 522 of the second magnet accommodating hole 52.

For example, in the present embodiment, the third low saturation magnetic flux density portion 530 is formed in the inner wall portion 531 of the third magnet accommodating hole 53, but the third low saturation magnetic flux density portion 530 may be formed in the outer wall portion 532 of the third magnet accommodating hole 53, or may be formed in both the inner wall portion 531 and the outer wall portion 532 of the third magnet accommodating hole 53.

For example, in the present embodiment, the rotor 10 for the rotary electric machine includes the first low saturation magnetic flux density portion 510 formed in the first magnet accommodating hole 51, the second low saturation magnetic flux density portion 520 formed in the second magnet accommodating hole 52, and the third low saturation magnetic flux density portion 530 formed in the third magnet accommodating hole 53, but the rotor 10 for the rotary electric machine may include at least one of the first low saturation magnetic flux density portion 510, the second low saturation magnetic flux density portion 520, and the third low saturation magnetic flux density portion 530.

In other words, any one or two of the first low saturation magnetic flux density portion 510, the second low saturation magnetic flux density portion 520, and the third low saturation magnetic flux density portion 530 may be omitted.

In the present specification, at least the following matters are described. Corresponding components and the like in the embodiments described above are shown as an example in parentheses, but the present invention is not limited thereto.

(1) A rotor (rotor 10) for a rotary electric machine (rotary electric machine 1) including:

a rotor core (rotor core 20) having a substantially annular shape centered on a rotation axis (rotation axis RC) and configured by laminating a plurality of sheet-shaped members (electromagnetic steel sheets 40); and

a plurality of magnetic pole portions (magnetic pole portions 30) formed in the rotor core along a circumferential direction, in which:

each of the magnetic pole portions includes magnet accommodating holes (first magnet accommodating hole 51, second magnet accommodating hole 52, third magnet accommodating hole 53) formed in the rotor core and extending in an axial direction, and permanent magnets (first permanent magnet 61, second permanent magnet 62, third permanent magnet 63) accommodated in the magnet accommodating hole;

each of the permanent magnets includes a first main surface (inner surfaces 611, 621, 631) extending in the axial direction and a second main surface (outer surfaces 612, 622, 632) extending in the axial direction;

each of the magnet accommodating holes includes a first wall portion (inner wall portions 511, 521, 531) facing the first main surface of each of the permanent magnets and extending in the axial direction, and a second wall portion (outer wall portions 512, 522, 532) facing the second main surface of each of the permanent magnets and extending in the axial direction;

in at least one of magnet accommodating holes of the rotor core, the sheet-shaped member in which a distance between the first main surface of each of the permanent magnets and the first wall portion of each of the magnet accommodating holes or a distance between the second main surface of each of the permanent magnets and the second wall portion of each of the magnets accommodating hole is a first distance (first distances D11, D21, D31), and the sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is a second distance (second distances D12, D22, D32) are laminated in the axial direction; and

the first distance is smaller than the second distance.

According to (1), in at least one of the magnet accommodating holes of the rotor core, the sheet-shaped member in which the distance between the first main surface of each of the permanent magnets and the first wall portion of each of the magnet accommodating holes or the distance between the second main surface of each of the permanent magnets and the second wall portion of each of the magnet accommodating holes is the first distance, and the sheet-shaped member in which the distance between the first main surface of each of the permanent magnets and the first wall portion of each of the magnet accommodating holes or the distance between the second main surface of each of the permanent magnets and the second wall portion of each of the magnet accommodating holes is the second distance are laminated in the axial direction, and the first distance is smaller than the second distance, so that a protrusion and a void are formed between the first main surface of each of the permanent magnets and the first wall portion of each of the magnet accommodating holes, or between the second main surface of each of the permanent magnets and the second wall portion of each of the magnet accommodating holes, when viewed in the axial direction. Accordingly, a low saturation magnetic flux density portion having a saturation magnetic flux density lower than that of a portion where the sheet-shaped members are laminated in the axial direction without the void being formed is formed between the first main surface of the permanent magnet and the first wall portion of the magnet accommodating hole, or between the second main surface of the permanent magnet and the second wall portion of the magnet accommodating hole. In this way, the low saturation magnetic flux density portion can be easily formed.

(2) The rotor for the rotary electric machine according to (1), in which:

a plurality of magnet insertion holes (magnet insertion holes 70) penetrating in the axial direction are formed in each of the plurality of sheet-shaped members along the circumferential direction;

each of the magnet accommodating holes is formed by laminating the plurality of sheet-shaped members in the axial direction and overlapping the magnet insertion holes formed in each of the sheet-shaped members in the axial direction;

the magnet insertion hole includes:
at least one first magnet insertion hole (protrusion forming magnet insertion hole 71) in which a distance between the first main surface of each of the permanent magnets and the first wall portion of each of the magnet accommodating holes or a distance between the second main surface of each of the permanent magnets and the second wall portion of each of the magnet accommodating holes is the first distance; and
at least one second magnet insertion hole (void forming magnet insertion hole 72) in which a distance between the first main surface of each of the permanent magnets and the first wall portion of each of the magnet accommodating holes or a distance between the second main surface of each of the permanent magnets and the second wall portion of each of the magnet accommodating holes is the second distance; and

each of the magnet accommodating holes is formed by overlapping the at least one first magnet insertion hole and the at least one second magnet insertion hole in the axial direction.

According to (2), since the low saturation magnetic flux density portion can be formed simply by overlapping in the axial direction the first magnet insertion hole and the second magnet insertion hole formed in the sheet-shaped members, the low saturation magnetic flux density portion can be easily formed.

(3) The rotor for the rotary electric machine according to (2), in which:

the at least one first magnet insertion hole comprises a plurality of first magnet insertion holes:

the at least one second magnet insertion hole comprises a plurality of second magnet insertion holes:

each of the plurality of the sheet-shaped members includes:
a first sheet-shaped member (first electromagnetic steel sheet 41) in which the plurality of first magnet insertion holes are formed along the circumferential direction; and
a second sheet-shaped member (second electromagnetic steel sheet 42) in which the plurality of second magnet insertion holes are formed along the circumferential direction; and

the magnet accommodating holes are formed by overlapping the first magnet insertion holes and the second magnet insertion holes in the axial direction and laminating the first sheet-shaped member and the second sheet-shaped member.

According to (3), the low saturation magnetic flux density portion can be formed simply by laminating the first sheet-shaped member in which the first magnet insertion hole is formed and the second sheet-shaped member in which the second magnet insertion hole is formed in the axial direction. Accordingly, since the low saturation magnetic flux density portion can be formed simply by preparing two types of sheet-shaped members and laminating the sheet-shaped members in the axial direction, the low saturation magnetic flux density portion can be formed easily at low cost.

(4) The rotor for the rotary electric machine according to (2), in which:

the plurality of magnet insertion holes formed in one of sheet-shaped members (electromagnetic steel sheets 40A. 40B, 40C, 40D, 40E) are configured such that the at least one first magnet insertion hole and the at least one second magnet insertion hole are arranged in a predetermined pattern along the circumferential direction; and

the magnet accommodating holes are formed by overlapping the at least one first magnet insertion hole and the at least one second magnet insertion hole in the axial direction and laminating the plurality of sheet-shaped members in the axial direction while rotating the sheet-shaped members by a predetermined angle in the circumferential direction.

According to (4), the first magnet insertion hole and the second magnet insertion hole are formed to overlap each other in the axial direction by laminating in the axial direction the sheet-shaped members, in each of which the first magnet insertion hole and the second magnet insertion hole are arranged in the predetermined pattern along the circumferential direction, while rotating the sheet-shaped members by the predetermined angle in the circumferential direction. Accordingly, since the low saturation magnetic flux density portion can be formed of one type of sheet-shaped member, the low saturation magnetic flux density portion can be easily formed at low cost.

(5) The rotor for the rotary electric machine according to (2), in which:

each of the sheet-shaped members includes:
a first magnetic pole portion forming portion (first magnetic pole portion forming portion 81) in which the at least one first magnet insertion hole is formed; and
a second magnetic pole portion forming portion (second magnetic pole portion forming portion 82) in which the at least one second magnet insertion hole is formed; and

the magnetic pole portion is formed by overlapping the first magnetic pole portion forming portion and the second magnetic pole portion forming portion and laminating the plurality of sheet-shaped members in the axial direction while rotating the sheet-shaped members by a predetermined angle in the circumferential direction.

According to (5), the first magnet insertion hole and the second magnet insertion hole are formed to overlap each other in the axial direction by laminating in the axial direction the sheet-shaped members each having the first magnetic pole portion forming portion and the second magnetic pole portion forming portion while rotating the sheet-shaped members by the predetermined angle in the circumferential direction. Accordingly, since the low saturation magnetic flux density portion can be formed of one type of sheet-shaped member, the low saturation magnetic flux density portion can be easily formed at low cost.

(6) The rotor for the rotary electric machine according to (2), in which

each of the plurality of sheet-shaped members includes a plurality of magnetic pole portion forming portions (first magnetic pole portion forming portion 81, second magnetic pole portion forming portion 82, third magnetic pole portion forming portion 83) each having a plurality of the magnet insertion holes:

the plurality of magnet insertion holes formed in at least one of the magnetic pole portion forming portions (third magnetic pole portion forming portion 83) include the at least one first magnet insertion hole and the at least one second magnet insertion hole; and

wherein the magnetic pole portion is formed by overlapping the magnetic pole portion forming portions by laminating the plurality of sheet-shaped members in the axial direction while rotating the sheet-shaped members by a predetermined angle in the circumferential direction.

According to (6), since the plurality of magnet insertion holes formed in at least one of the magnetic pole portion forming portions include the first magnet insertion hole and the second magnet insertion hole, the low saturation magnetic flux density portions formed in the plurality of magnet accommodating holes formed in one magnetic pole portion can have different saturation magnetic flux densities.

(7) The rotor for the rotary electric machine according to (1), in which:

the rotor core is configured by laminating in the axial direction a first sheet-shaped member (first electromagnetic steel sheet 41) in which a distance between the first main surface of each of the permanent magnets and the first wall portion of each of the magnet accommodating holes or a distance between the second main surface of each of the permanent magnets and the second wall portion of each of the magnet accommodating holes is the first distance, and a second sheet-shaped member (second electromagnetic steel sheet 42) in which a distance between the first main surface of each of the permanent magnets and the first wall portion of each of the magnet accommodating holes or a distance between the second main surface of each of the permanent magnets and the second wall portion of each of the magnet accommodating holes is the second distance.

According to (7), the low saturation magnetic flux density portion can be formed only by laminating in the axial direction the first sheet-shaped member in which the distance between the first main surface of each of the permanent magnets and the first wall portion of each of the magnet accommodating holes or the distance between the second main surface of each of the permanent magnets and the second wall portion of each of the magnet accommodating holes is the first distance, and the second sheet-shaped member in which the distance between the first main surface of each of the permanent magnets and the first wall portion of each of the magnet accommodating holes or the distance between the second main surface of each of the permanent magnets and the second wall portion of each of the magnet accommodating holes is the second distance. Accordingly, since the low saturation magnetic flux density portion can be formed simply by preparing two types of sheet-shaped members and laminating the sheet-shaped members in the axial direction, the low saturation magnetic flux density portion can be formed easily at low cost.

(8) A rotor (rotor 10) for a rotary electric machine (rotary electric machine 1) including:

a rotor core (rotor core 20) having a substantially annular shape centered on a rotation axis (rotation axis RC) and configured by laminating a plurality of sheet-shaped members (electromagnetic steel sheets 40); and

a plurality of magnetic pole portions (magnetic pole portions 30) formed in the rotor core along a circumferential direction, in which:

each of the magnetic pole portions includes a magnet accommodating hole (first magnet accommodating hole 51, second magnet accommodating hole 52, third magnet accommodating hole 53) formed in the rotor core and extending in an axial direction, and a permanent magnet (first permanent magnet 61, second permanent magnet 62, third permanent magnet 63) accommodated in the magnet accommodating hole;

the permanent magnet includes a first main surface (inner surfaces 611, 621, 631) extending in the axial direction and a second main surface (outer surfaces 612, 622, 632) extending in the axial direction;

the magnet accommodating hole includes a first wall portion (inner wall portions 511, 521, 531) facing the first main surface of the permanent magnet and extending in the axial direction, and a second wall portion (outer wall portions 512, 522, 532) facing the second main surface of the permanent magnet and extending in the axial direction; and

a plurality of protrusions (first protrusions 510a, second protrusions 520a, third protrusions 530a) protruding toward the permanent magnet to form at least one of the first wall portion and the second wall portion, and formed along the axial direction are provided, and

a plurality of voids (first voids 510b, second voids 520b, third voids 530b) formed between the plurality of protrusions which are adjacent, and formed along the axial direction are provided.

According to (8), in the rotor for the rotary electric machine, the plurality of protrusions formed along the axial direction and the plurality of voids formed along the axial direction are formed in at least one of the first wall portion and the second wall portion of the magnet accommodating hole. Accordingly, a low saturation magnetic flux density portion having a saturation magnetic flux density lower than that of a portion where the sheet-shaped members are laminated in the axial direction without the void being formed is formed between the first main surface of the permanent magnet and the first wall portion of the magnet accommodating hole, or between the second main surface of the permanent magnet and the second wall portion of the magnet accommodating hole. In this way, the low saturation magnetic flux density portion can be easily formed.

1. A rotor for a rotary electric machine comprising:
a rotor core having a substantially annular shape centered on a rotation axis and configured by laminating a plurality of sheet-shaped members; and
a plurality of magnetic pole portions formed in the rotor core along a circumferential direction, wherein:
each of the magnetic pole portions includes magnet accommodating holes formed in the rotor core and extending in an axial direction, and permanent magnets accommodated in the magnet accommodating hole;
each of the permanent magnets includes a first main surface extending in the axial direction and a second main surface extending in the axial direction;
each of the magnet accommodating holes includes a first wall portion facing the first main surface of each of the permanent magnets and extending in the axial direction, and a second wall portion facing the second main surface of each of the permanent magnets and extending in the axial direction;
in at least one of the magnet accommodating holes of the rotor core, the sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is a first distance, and the sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is a second distance are laminated in the axial direction; and
the first distance is smaller than the second distance.

2. The rotor for the rotary electric machine according to claim 1, wherein:
a plurality of magnet insertion holes penetrating in the axial direction are formed in each of the plurality of sheet-shaped members along the circumferential direction;
each of the magnet accommodating holes is formed by laminating the plurality of sheet-shaped members in the axial direction and overlapping the magnet insertion holes formed in each of the sheet-shaped members in the axial direction;
the magnet insertion hole includes:
at least one first magnet insertion hole in which a distance between the first main surface of each of the permanent magnets and the first wall portion of each of the magnet accommodating holes or a distance between the second main surface of each of the permanent magnets and the second wall portion of each of the magnet accommodating holes is the first distance; and
at least one second magnet insertion hole in which a distance between the first main surface of each of the permanent magnets and the first wall portion of each of the magnet accommodating holes or a distance between the second main surface of each of the permanent magnets and the second wall portion of each of the magnet accommodating holes is the second distance; and
each of the magnet accommodating holes is formed by overlapping the at least one first magnet insertion hole and the at least one second magnet insertion hole in the axial direction.

3. The rotor for the rotary electric machine according to claim 2, wherein:
the at least one first magnet insertion hole comprises a plurality of first magnet insertion holes;
the at least one second magnet insertion hole comprises a plurality of second magnet insertion holes;
each of the plurality of the sheet-shaped members includes:
a first sheet-shaped member in which the plurality of first magnet insertion holes are formed along the circumferential direction; and
a second sheet-shaped member in which the plurality of second magnet insertion holes are formed along the circumferential direction; and
the magnet accommodating holes are formed by overlapping the first magnet insertion holes and the second magnet insertion holes in the axial direction and laminating the first sheet-shaped member and the second sheet-shaped member.

4. The rotor for the rotary electric machine according to claim 2, wherein:
the plurality of magnet insertion holes formed in one of sheet-shaped members are configured such that the at least one first magnet insertion hole and the at least one second magnet insertion hole are arranged in a predetermined pattern along the circumferential direction; and
the magnet accommodating holes are formed by overlapping the at least one first magnet insertion hole and the at least one second magnet insertion hole in the axial direction and laminating the plurality of sheet-shaped members in the axial direction while rotating the sheet-shaped members by a predetermined angle in the circumferential direction.

5. The rotor for the rotary electric machine according to claim 2, wherein:
each of the sheet-shaped members includes:
a first magnetic pole portion forming portion in which the at least one first magnet insertion hole is formed; and
a second magnetic pole portion forming portion in which the at least one second magnet insertion hole is formed; and
the magnetic pole portion is formed by overlapping the first magnetic pole portion forming portion and the second magnetic pole portion forming portion and laminating the plurality of sheet-shaped members in the axial direction while rotating the sheet-shaped members by a predetermined angle in the circumferential direction.

6. The rotor for the rotary electric machine according to claim 2, wherein:
each of the plurality of sheet-shaped members includes a plurality of magnetic pole portion forming portions each having a plurality of the magnet insertion holes; and
the plurality of magnet insertion holes formed in at least one of the magnetic pole portion forming portions include the at least one first magnet insertion hole and the at least one second magnet insertion hole.

7. The rotor for the rotary electric machine according to claim 1, wherein:
the rotor core is configured by laminating in the axial direction a first sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is the first distance, and a second sheet-shaped member in which a distance between the first main surface of each of the permanent magnets and the first wall portion of each of the magnet accommodating holes or a distance between the second main surface of each of the permanent magnets and the second wall portion of each of the magnet accommodating holes is the second distance.

8. A rotor for a rotary electric machine comprising:
a rotor core having a substantially annular shape centered on a rotation axis and configured by laminating a plurality of sheet-shaped members; and
a plurality of magnetic pole portions formed in the rotor core along a circumferential direction, wherein:
each of the magnetic pole portions includes a magnet accommodating hole formed in the rotor core and extending in an axial direction, and a permanent magnet accommodated in the magnet accommodating hole;
the permanent magnet includes a first main surface extending in the axial direction and a second main surface extending in the axial direction;
the magnet accommodating hole includes a first wall portion facing the first main surface of the permanent magnet and extending in the axial direction, and a second wall portion facing the second main surface of the permanent magnet and extending in the axial direction; and
a plurality of protrusions protruding toward the permanent magnet to form at least one of the first wall portion and the second wall portion, and formed along the axial direction are provided; and
a plurality of voids formed between the plurality of protrusions which are adjacent, and formed along the axial direction are provided.
